(19) United States
(12) Patent Application Publication
(10) Pub. No.: US 2010/0080957 A1
(43) Pub. Date: Apr. 1, 2010

(54) Surface Coating

(75) Inventors: Jeffrey D. CHINN, Foster City, CA (US); Rolf GUENTHER, Monte Sereno, CA (US); Mark WILTSE, Redwood City, CA (US); William Robert ASHURST, Auburn, AL (US); Adam ANDERSON, Auburn, AL (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Integrated Surface Technologies, Menlo Park, CA (US)

(21) Appl. No.: 12/249,597

(22) Filed: Oct. 10, 2008

Related U.S. Application Data
(60) Provisional application No. 61/101,840, filed on Oct. 1, 2008.

(51) Int. Cl. C23F 11/00; B32B 5/16; B32B 9/00; B32B 15/04; B05D 5/00

(52) U.S. Cl. 428/147; 428/329; 428/148; 428/149; 428/411.1; 428/704; 428/333; 428/457; 428/143; 428/331; 428/447; 428/336; 427/248.1; 427/256

(57) ABSTRACT

A corrosion barrier is provided, disposed on a substrate. The corrosion barrier includes a vapor corrosion inhibitor (VCI) material and an anti-wetting barrier having a nano-particle composite structure.

### CROSS-REFERENCES TO RELATED APPLICATIONS

This application is related to Provisional Application Ser. Nos. 61/029,801, filed Feb. 19, 2008, 60/983,504, filed Oct. 29, 2007, application Ser. No. 12/115,874, filed May 6, 2008, application Ser. No. 12/115,875, filed May 6, 2008, application Ser. No. 12/209,593, filed Sep. 12, 2008, and application Ser. No. 12/209,629, filed Sep. 12, 2008.

### BACKGROUND

Today's conformal coatings include glob-top organic based coatings. Such coatings include acrylics, epoxies, urethanes, parylene or silicone materials. Such conformal coatings provide limited environmental protection from moisture, dust, vibration, and provide physical protection from handling.

Today's conformal coatings are typically several mils thick. The thinnest conformal coating produced today is made of vapor-deposited parylene and is about 15 μm thick. Thick conformal coatings can be problematic. For example, during any rework of a printed circuit board, a previously applied thick conformal coating may need to be removed (e.g., by dissolution or physical abrasion). This is time consuming, expensive and difficult. Also, thick conformal coatings can undesirably impede the transfer of heat from an electrical apparatus such as a chip or circuit substrate.

Conformal coatings are also not completely foolproof. Conformal coatings are typically not applied over electrical connectors as they affect the contact resistance. For example, if a cell phone with a thick conformal coating is immersed in a body of water, there is a high probability that the phone will not work. This is because residues or contaminated liquids can form leakage pathways between the various exposed components, connectors, assemblies or surfaces not coated.

Improvements can be made to such coatings.

### SUMMARY

Novel surface coatings are provided, including articles having such surface coatings, and methods for forming surface coatings.

A corrosion barrier disposed on a substrate is provided. The corrosion barrier includes an anti-wetting barrier disposed over the substrate. The anti-wetting barrier comprises a nano-particle composite structure. The corrosion barrier also includes a vapor corrosion inhibitor (VCI) material.

The VCI material may be a separate layer disposed on the substrate, and the anti-wetting barrier may be deposited over or on the VCI layer. The VCI material may be mixed or co-deposited with the anti-wetting barrier.

Preferably, a dual layer corrosion barrier is provided, disposed on a substrate. The corrosion barrier includes a vapor corrosion inhibitor (VCI) layer disposed on the substrate. The corrosion barrier also includes an anti-wetting barrier disposed on the vapor corrosion inhibitor layer, the anti-wetting barrier having a nano-particle composite structure.

Preferred VCI materials include sodium hexametaphosphate, diethylaminoethanol, dicyclohexyl amine nitrite, camphor, benzotriazole, dicyclohexyl amine nitrite, cyclohexlamine carbonate, morpholine, cyclohexylamine aniline, benzylamine, N-cyclohexyl-n-dodecylamine, piperidine and di-n-butylamine. Organic VCI layers may be preferred for many applications. Benzotriazole is particularly preferred. The VCI layer is preferably one-molecule thick.

Preferred substrate materials include copper, iron, silver, aluminum, tin, zinc, and alloys thereof. These materials may be subject to corrosion, and may be protected by the dual layer corrosion barrier disclosed herein.

The nano-particle composite structure preferably has an RMS surface roughness of 25 nm to 500 nm, a film coverage of 25% to 60% and a thermodynamic surface energy of <70 dyne/cm.

When the substrate is a printed circuit board, the dual layer corrosion barrier preferably has a durability of 10 to 5000 microNewtons. Other preferred durability ranges include 10 to 500 microNewtons.

The anti-wetting barrier may comprise non-conductive particles linked to each other and to the substrate by linker molecules. The non-conductive particles may be metal oxide or semiconductor oxide particles. The non-conductive particles may be alumina, preferably having a particle size of about 40-60 nm, or silica particles, preferably having a particle size of about 10-20 nm. The non-conductive particles may be latex particles. The nano-particles shape could be round spheres, flatten discs, rods, nails, hollow spheres or other shapes with the preferred diameter.

Preferred linker molecules include bi-functional linkers such as bis-trichlorosilane-ethane, bis-trichlorosilane-butane, bis-trichlorosilane-hexane, bis-trimethoxysilane-ethane, bis-trimethoxysilane-butane, bis-trimethoxysilane-hexane, bis-tris-dimethylaminosilane-ethane, bis-tris-dimethylaminosilane-butane, bis-tris-dimethylaminosilane-hexane and tetrachlorosilane. Preferred linker molecules include silanes with a reactive group at both ends.

The anti-wetting barrier may further include a low thermodynamic surface energy coating, having a surface energy of less than 70 dyne/cm, disposed over the non-conductive particles and linker molecules. Preferred classes of materials for the low surface energy coating include long chain hydrocarbons, long chain fluorocarbons, phosphonates, thiols and ring structures. Preferred materials for the low surface energy coating include C8, C10, C11, C12, C14, C18, FDTS, FODCMS or FOTS.

Preferably the corrosion barrier has a total thickness of 0.05 to 15 microns.

Preferably, the anti-wetting barrier has a water vapor transmission rate of 0.01 to 3 g/(m²*day).

The substrate may be a consumer electronic device.

A preferred specific corrosion barrier includes a vapor corrosion inhibitor layer comprises a material selected from the group consisting of sodium hexametaphosphate, diethylaminoethanol, dicyclohexyl amine nitrite, camphor, benzotriazole, dicyclohexyl amine nitrite, cyclohexlamine carbonate, morpholine, cyclohexylamine aniline, benzylamine, N-cyclohexyl-n-dodecylamine, piperidine and di-n-butylamine. The preferred specific corrosion barrier further includes and anti-wetting barrier further that comprises non-conductive particles linked to each other and to the substrate by linker molecules, and a low thermodynamic surface energy coating disposed over the non-conductive particles and linker molecules, the low surface energy coating comprising a material selected from the group consisting of long chain hydrocarbons, long chain fluorocarbons, phosphonates, thiols and ring structures.

A method of fabricating a corrosion barrier is provided. A vapor corrosion inhibitor (VCI) layer is provided on a substrate. An anti-wetting barrier is deposited, via a vapor process, over the vapor corrosion inhibitor layer, the anti-wetting barrier comprising a nano-particle composite structure. Methods of providing the VCI layer include via a vapor process and via a wet process.

Nano-particles may be deposited on a substrate surface using a liquid deposition process, to form an ionic barrier with anti-wetting or super-hydrophobic properties on the substrate.

These and other embodiments of the invention are described in detail below.

A low surface energy coating, having a thermodynamic surface energy of less than 70 dyne/cm, may be disposed over the non-conductive particles and linker molecules. Preferred materials for the low surface energy coating include materials selected from the group consisting of long chain hydrocarbons, long chain fluorocarbons, phosphonates, thiols and rings. Specific preferred materials include C8 (n-Octyltrichlorosilane (C₈H₁₇Cl₃Si)), C10 (n-Decyltrichlorosilane (C₁₀H₂₁Cl₃Si) ) or n-Decyltriethoxysilane (C₁₆H₃₆C₁₃Si), C11 (Undecyltrichlorosilane (C₁₁H₂₃Cl₃Si)), C12 (Dodecyltrichlrosilane (C₁₂H₂₅Cl₃Si)) or Dodecylthriethoxysilane (C₁₈H₄₀O₃Si)), C14 (Tetradecyltrichlorosilane (C₁₄H₂₅Cl₃Si)), C18 (n-Octadecyltrichlorosilane (C₁₈H₃₇Cl₃Si)) or (n-Octadecyltrimethoxylsilane (C₂₁H₄₆O₃Si)), FDTS ((Heptadecafluoro-1,1,2,2-TetraHydrodecyl)Trichlorosilane (C₁₀H₄Cl₃Fl₇Si)), FODCMS ((Tridecafluor-1,1,2,2-Tetrahydro-Octyl)methyldichlorosilane) (C₉H₇Cl₂Fi₃Si)), FOTS ((Tridecafluoro-1,1,2,2-Tetrahydro-Octyl)Trichlorosilane C₈H₄Cl₃Fi₃Si)) or rings like structures (Pentafluorophenylpropyl-trichlorosilane (C₉H₆F₅Cl₃Si)).

Preferably, the nanoparticles pre-treated with protected linker molecules prior to deposition on a surface of a substrate, and the nanoparticles are linked to each other and to the surface using the linker molecules by deprotecting the linker molecules.

Embodiments of the invention are directed to specific combinations of these different aspects, as well as specific embodiments related to those specific aspects. Further details regarding embodiments of the invention are provided below in the Detailed Description, Claims, and Appendix.

### BRIEF DESCRIPTION OF THE DRAWINGS

FIG. 1 shows a diagram illustrating components of a composite film.

FIG. 2 shows an illustration of three surfaces having the same RMS surface roughness but different surface coverages. Both topographical and digital coverage views of the surfaces are provided.

FIG. 3 shows surfaces for which surface coverage has been calculated. FIGS. 3A, 3C and 3E show scanning electron microscope (SEM) images of 3 different surfaces. FIGS. 3B, 3D and 3F show digital images corresponding to the SEM images of FIGS. 3A, 3C and 3E, respectively.

FIG. 4 shows wear images.

FIG. 5 shows a table with test data of films which have been treated with various low surface energy coatings.

FIG. 6 shows a Venn diagram illustrating an intersection between preferred property ranges.

FIG. 7 shows a schematic of an apparatus that may be used to fabricate coatings.

FIG. 8 shows an apparatus that may be used to fabricate coatings.

FIG. 9 shows printed circuit boards with various coatings after exposure to an ionic solution.

FIG. 10 shows atomic force microscopy measurements of surfaces having a texturized coating applied using different process parameters.

FIG. 11 shows USB memory devices with various coatings, including no coating, and at various magnifications exposed to an ionic electrolyte of Gatorade®.

FIG. 12, including FIGS. 12A, 12B, 12C and 12D show scanning electron micrographs (SEM) of coatings at different magnifications which do not exhibit the desired properties due to a lack of surface coverage.

FIG. 13, including FIGS. 13A, 13B, 13C and 13D show scanning electron micrographs (SEM) of coatings at different magnifications. The coating of FIG. 13 was fabricated differently from that of FIG. 12, and has a different surface coverage which does exhibit the desired properties.

FIG. 14 shows several scanning electron micrographs (SEM) of a cross section of a sample similar to that illustrated in FIG. 13.

FIG. 15, including FIGS. 15A and 15B show scratch test data of two films in which one was treated with a linker chemistry.

FIG. 16, including FIGS. 16A, 16B, 16C and 16D shows surface coverage measurements. FIGS. 16A and 16C show SEM micrographs at different magnifications. FIGS. 16B and 16D are their corresponding digitized coverage images.

FIG. 17, including FIGS. 17A, 17B and 17C show the results of scratch testing on different films and/or with different testing parameters.

FIG. 18 shows a dual layer corrosion barrier.

FIG. 19 shows samples after corrosion testing via dipping into a liquid. The samples have no treatment, either a VCI layer, an anti-wetting barrier, or both.

FIG. 20 shows samples after corrosion testing via a humidity stress test. The samples have no treatment, either a VCI layer, an anti-wetting barrier, or both.

FIG. 21 shows samples after corrosion testing via a humidity stress test. The samples have no treatment, a VCI layer, or both a VCI layer and an anti-wetting barrier.

FIG. 22 shows samples after corrosion testing via a humidity stress test, at 10× magnification. The samples have no treatment, or just a VCI layer.

FIG. 23 shows samples after corrosion testing via a humidity stress test, at 10× magnification. The samples have both a VCI layer and an anti-wetting barrier.

### DETAILED DESCRIPTION

Corrosion results in significant material failures and billions of dollars in losses every year. Corrosion damage may affect many areas, including electronics, mechanical devices, artwork, and others.

A common method of protecting against corrosion is apply a top-coat or barrier layer. Barrier layers include paints, polymers and organic coatings of urethanes, expoxies, acrylics. For many applications, typical thickness of these barrier layers 25 μm to 125 μm.

Another way to protect against corrosion is to use a corrosion inhibitor. A corrosion inhibitor is different than a top-coat in that it binds to the surface. Corrosion inhibitors may be very material dependent, and may also be vulnerable to liquids, which are disadvantages.

Corrosion is an electrochemical reaction between a media and its environment. Corrosion is often caused by moisture. Moisture may be liquid or gaseous in nature. “Hydrophobicity” is the ability of a surface to repel liquids. “Gas permeability” is the susceptibility of a layer to penetration by a gas, including moisture in a gaseous phase. A layer having a high hydrophobicity does not necessarily have a low gas permeability.

Vapor phase corrosion inhibitors (VCIs) may be applied to a surface to protect it from corrosion. A VCI may be volatilized to form a thin deposition layer on nearby surfaces. Preferably, but not necessarily, this volatilization may be done at room temperature. The ability of a VCI to minimize corrosion was first discovered in the early 1900's but not commercially applied until the 1950s, when it was used by Shell to protect military equipment.

Vapor-phase corrosion inhibitors (VCI) have been used to form complexes on the surface of metals (copper, iron, silver, aluminum, tin, zinc and their alloys) to retard corrosion and tarnishing effects. VCI's are widely used in artifact preservation in museums, ventilation systems, and piping systems. However, VCIs may fail if they are exposed to aqueous sprays or liquids which dissolve the VCIs. Thus a VCI has limited use in environments in which droplets or wetting may occur. VCI's also can be attacked in various oxidizing and halogenated environments where condensation occurs.

In general, a VCI is volatile substance used to minimize corrosion or tarnish of metals. Some VCI compounds are non-reactive and simply provide a barrier layer that minimizes oxidation and tarnishing of metals. Other VCI compounds are basic, such as an amines that react with acids in the environment. Strongly basic compounds, such as sodium hexametaphosphate, diethylaminoethanol, morpholine, etc. may be used in HVAC and fire suppression systems to minimize pipe corrosion. Some of the less reactive VCI compounds, such as dicyclohexyl amine nitrite, camphor, benzotriazole, etc. have been incorporated in anti-tarnish papers or enclosed in storage/display cases. A review of VCI's as used on copper artifacts is provided in Robert Faltermeier, A Corrosion Inhibitor Test for Copper-Based Artifacts, Studies of Conservation 44 (1998) 121-128. VCI materials generally form a protective layer that is a single molecule or only a few molecules thick. While VCI materials generally have vapor pressures high enough that they may be applied by volatilizing the compound (VCI may also refer to “volatile” corrosion inhibitor), they may also be applied via solution processing as described herein.

Some VCI include dicyclohexyl amine nitrite, which has a vapor pressure=0.00013 torr@21C, and a pH of condensate=10.0; benzotriazole, which has a vapor pressure=0.04 torr@20C; cyclohexlamine carbonate, which has a vapor pressure=0.397 torr@25C, and morpholine, which has a vapor pressure=8 torr@20C. Some VCI materials are suspected carcinogens.

Benzotriazole (BTA) is used in the electronic industry for protecting copper. It has a low cost, $25 for 100 gms. U.S. Pat. No. 7,144,802 to Texas Instruments discloses the use of BTA to protect copper during IC interconnect. BTA is commonly used to protect copper traces on printed circuit boards from oxidation. BTA may be applied in solution (dipping) or by vapor. BTA may be applied in a solution of IPA. During soldering, high temperature may volatilize BTA, leaving an oxide free surface for good solder connection. BTA has been used to protect metals including copper, iron, silver, aluminum, tin, zinc and their alloys. The use of BTA as a corrosion inhibitor is described in T. Callender & L. C. Davis, Journal of Hazardous Substance Research, Volume Four, 2-1, 2002.

BTA works as a VCI because a triazole functional group binds on the metal, resulting in a protective film on the surface. A protective film of BTA, and more generally VCI films, provide a layer having a low vapor permeability, and thus protect against moisture in the vapor phase. However, such a protective film may be readily dissolved by aqueous solutions, substantially dissolved in an acid or alkali environment, or evaporated at a high temperature (80° C.). Example 12 shows that VCI may not provide corrosion protection in an aqueous environment. In addition, BTA may not prevent a metal surface from corroding over long periods of time.

A corrosion barrier disposed on a substrate is provided. The corrosion barrier includes an anti-wetting barrier disposed over the substrate. The anti-wetting barrier comprises a nano-particle composite structure. The corrosion barrier also includes a vapor corrosion inhibitor (VCI) material. The VCI material may be a separate layer disposed on the substrate, and the anti-wetting barrier may be deposited over or on the VCI layer. The VCI material may be mixed or co-deposited with the anti-wetting barrier. The anti-wetting barrier and the VCI material complement each other. An anti-wetting barrier alone may provide protection against liquids but, due to the porosity if the barrier, not against vapor-born moisture. A VCI material may provide protection against vapor-born moisture but be vulnerable to rapid degradation by liquids. The combination of a VCI material and an anti-wetting barrier may provide protection against both liquids and vapor-born moisture. The anti-wetting barrier may also protect the VCI material from exposure to liquids. The anti-wetting barrier itself does not necessarily need to be protected from vapor-born moisture, but the VCI material may protect the underlying substrate from any vapor-born moisture that penetrates a porous anti-wetting barrier.

Preferably, a dual layer corrosion barrier disposed on a substrate is provided. The corrosion barrier includes a vapor corrosion inhibitor layer disposed on the substrate, and an anti-wetting barrier disposed on the vapor corrosion inhibitor layer. The anti-wetting barrier comprises a nano-particle composite structure. Such a dual layer corrosion barrier provides the favorable resistance of a VCI layer to corrosion, while also being hydrophobic, i.e., resistant to liquids. Each of the two layers, the VCI layer and the anti-wetting barrier, compensates for the weakness of the other. The anti-wetting barrier protects the VCI layer, which is vulnerable to liquids, against exposure to liquids. The VCI layer protects the underlying substrate against vapor, which may be able to pass through the anti-wetting barrier.

Preferred VCI materials include sodium hexametaphosphate, diethylaminoethanol, dicyclohexyl amine nitrite, camphor, benzotriazole, dicyclohexyl amine nitrite, cyclohexlamine carbonate, morpholine, cyclohexylamine aniline, benzylamine, N-cyclohexyl-n-dodecylamine, piperidine and di-n-butylamine. Derivatives of these materials may also be useful as VCI materials, and other VCI materials may also be used. Organic VCI layers may be preferred for many applications. BTA is a preferred material for the VCI, since its use in the electronics industry is known.

Vapor application of BTA is preferred, because vapor application forms a single molecule, thin, uniform layer as opposed to clusters. A one molecule thick layer of BTA may be preferred. In addition, vapor application uses much less BTA to reduce waste and negative environmental effects.

Preferred substrate materials that may be protected from corrosion by a dual layer corrosion barrier include copper, iron, silver, aluminum, tin, zinc, and alloys thereof. Copper is a preferred material due to its interaction with VCI materials such as BTA.

Preferred parameters for use with a nano-particle composite structure used as a part of a dual layer corrosion barrier are:

an RMS surface roughness of 25 nm to 500 nm;

a film coverage of 25% to 60%; and

a thermodynamic surface energy of <70 dyne/cm.

These parameters provide for superior anti-wetting properties.

For some applications, where it may be desirable to remove the corrosion barrier when making an electrical connection, the nano-particle composite structure preferably has a durability of 10 to 5000 microNewtons, which is well-suited for a layer that would be removed by normal mechanical force applied during assembly of a printed circuit board. For other applications, such as those involving removal of a corrosion barrier during the formation of connections at the chip level, a durability of 10 to 500 microNewtons may be preferred.

Preferred configurations, materials and fabrication methods described herein for a nano-particle composite structure used alone may also be preferred for use in a nano-particle composite structure used in combination with a VCI layer to create a dual-layer corrosion barrier.

The porosity of the nano-particle composite structure may be readily controlled by varying factors such as particle size. Preferably, the nano-particle composite structure has a water vapor transmission rate of 0.01 to 3 g/(m²*day).

A dual layer corrosion barrier may be used to reduce corrosion for a wide variety of substrates, including printed circuit boards and consumer electronic devices. Other substrates, including those beyond the field of electronics, may also be protected. A total thickness of 0.05 to 15 microns for a dual layer corrosion barrier is preferred.

A preferred dual layer corrosion barrier includes a vapor corrosion inhibitor layer comprising a material selected from the group consisting of sodium hexametaphosphate, diethylaminoethanol, dicyclohexyl amine nitrite, camphor, benzotriazole, dicyclohexyl amine nitrite, cyclohexlamine carbonate, morpholine, cyclohexylamine aniline, benzylamine, N-cyclohexyl-n-dodecylamine, piperidine and di-n-butylamine. The preferred dual layer corrosion barrier also includes an anti-wetting barrier, that further includes non-conductive particles linked to each other and to the substrate by linker molecules; and a low thermodynamic surface energy coating disposed over the non-conductive particles and linker molecules, the low surface energy coating comprising a material selected from the group consisting of long chain hydrocarbons, long chain fluorocarbons, phosphonates, thiols and ring structures.

A dual layer corrosion barrier may be formed by a number of methods. VCI layers are well-known, and any method of forming a VCI layer may be used.

An anti-wetting barrier comprising a nano-particle composite structure may be deposited over the VCI layer by any suitable process. Depositing the anti-wetting barrier via a vapor process is preferred, because underlying VCI layers may be vulnerable to damage from liquid. Using a vapor process to deposit the anti-wetting barrier reduces damage to the VCI due to exposure to liquid.

It is preferred to deposit both the VCI and the anti-wetting barrier via vapor process. In this way, fabrication of the dual layer corrosion barrier can be simplified to involve the use of only a single piece of fabrication equipment that can expose the substrate sequentially to a variety of gases, while maintaining the advantages of avoiding exposure of the VCI to liquid.

However, the vapor corrosion inhibitor layer may also be deposited via a wet process. Wet processing for the VCI may be easier in some circumstances.

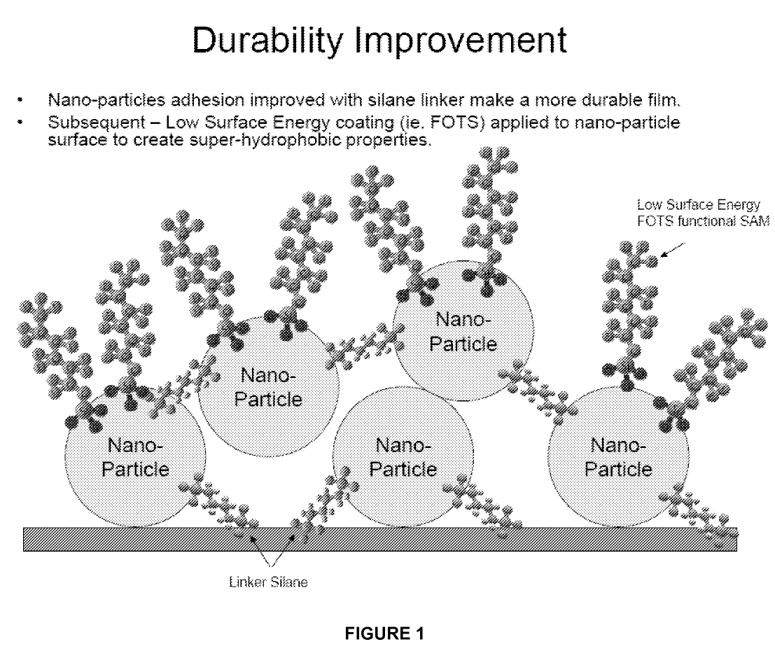

The anti-wetting barrier provides protection from moisture. FIGS. 1-8 and associated text describes a preferred anti-wetting barrier, that may be used in connection with a VCI layer to form a dual layer corrosion barrier. Examples of anti-wetting barriers are described in application Ser. No. 12/209,593, filed Sep. 12, 2008, and application Ser. No. 12/209,629, filed Sep. 12, 2008, which are incorporated by reference. A nano-composite film structure may exhibits super-hydrophobic properties or non-wetting properties. However, this composite film has a high degree of roughness and a high porosity/low density. As a result, the anti-wetting barrier may not provide a good barrier to gas-phase moisture. Such moisture susceptibility can result in corrosion of metal surfaces and material failure over time. Thus the nano-composite film has a weakness in that moisture can penetrate the film and still result in corrosion.

An anti-wetting film is provided, which can protect printed circuit boards and electronic assemblies from failures caused by ionic materials. Preferably, a special textured surface is created on an electrical apparatus such as a circuit substrate (e.g., a circuit board, a circuit card, a connector, etc.). This textured surface can be a barrier that can repel ionic contaminants. Most circuitry failures occur when contamination results in leakage or where conducting pathways form between the various electrical conductors (e.g., leads on a printed circuit board). Electrical leakage paths may also be prevented from forming.

FIG. 1 shows a diagram illustrating components of a texturized, composite film. Nanoparticles 120 are linked to each other and to a substrate 110 by linker molecules 130. A low surface energy coating 140 is disposed over the nanoparticles 120 and the linker molecules 630.

Nanoparticles 120 are preferably non-conductive. Metal oxide or semiconductor oxide particles are preferred. Specifically, alumina and silica particles are preferred. Where the nanoparticles are alumina, a particle size of about 40-60 nm, more preferably 40-50 nm, is preferred, where particle size is according to industry standard measurements that correlate more or less to the particle diameter. Where the nanoparticles are silica, a particle size of about 10-20 nm is preferred. Other types of nanoparticles may be used, including but not limited to latex nanoparticles. Hollow silica particles, which incorporate a substantial amount of air, may improve resistance to oils and other solvents.

Process parameters may be controlled to obtain a film having an RMS surface roughness of 25 nm to 500 nm, a film coverage of 25% to 60%, a surface energy of less than 70 dyne/cm, and a durability of 10 to 5000 microNewtons. Such a film is particularly desirable for the following reasons.

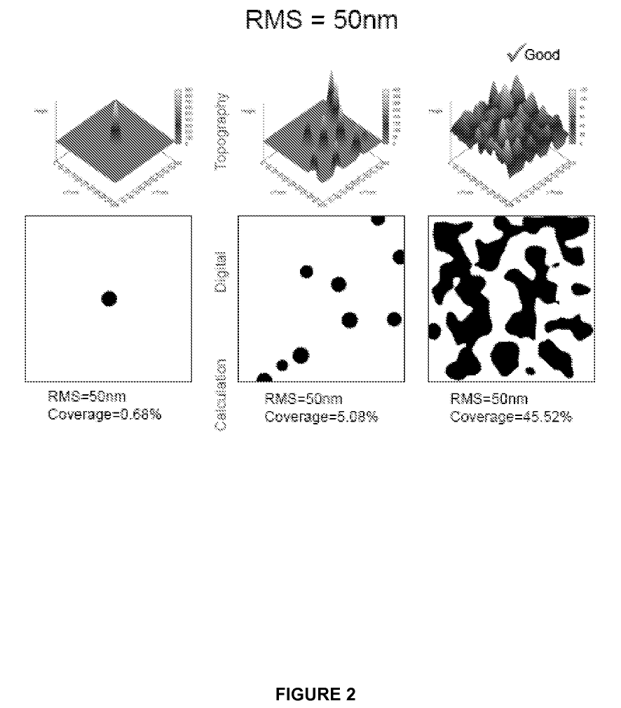

First, the combination of surface roughness, film coverage, and surface energy results in a film sufficiently resistant to wetting by aqueous solutions (water, coffee, sodas) and organic solvents to which electronics may be exposed during use. As a result, the electronics may survive conditions that would otherwise have rendered them inoperable. Each of the parameters is important. For example, as illustrated in FIG. 2, surface roughness alone is not sufficient to provide the type of surface desired, and two surfaces having the same surface roughness but different film coverage may have very different surface topography and, hence, different resistance to wetting.

Second, the durability range results in a film that is sufficiently durable to resist many of the environmental conditions to which an electronic device might be exposed. Durabilities that are too much lower may result in films that are removed during normal use of a device. However, the durability is still low enough to allow for convenient fabrication and rework. Specifically, the film may be applied to different parts before an electrical connection is made. Then, when the connection is made, the film has a durability low enough that the film may be readily removed during the connection process. A durability of 10 to 5000 microNewtons is sufficiently low to allow for connections at the printed circuit board level. Where a film that will allow for good electrical connections at the chip level is desired (eg. thin film flex circuit boards in which connections are spring-loaded contacts), a durability having a lower top range is preferred, i.e., a durability of 10 to 500 microNewtons is preferred.

A film thickness that is 3 to 100 times the surface roughness of the film is preferred. Such a film is thick enough to ensure that the underlying substrate is adequately protected from moisture, but is not so thick that fabrication times increase, excess material is present, or issues with electrical connections arise. Depending upon the application, however, much thicker films may be used, up to 10,000 times the RMS surface roughness, or even greater.

Substrate 110 may be any electrical part that can benefit from protection from fluids. A printed circuit board is one example of such a substrate. More generally, any electronic device may be used as a substrate. Consumer electronic devices, including flash memory, MP3 players, cell phones, personal digital assistants (PDAs), video game consoles, portable video game consoles, computers, laptops, monitors, keyboards and others, may be used as a substrate, where such devices have electronics that could benefit from water resistance protection.

When an electrical assembly includes a film having a texturized surface, a polluted or contaminated liquid may not be able to form a liquid-solid interface, which can lead to shorts and low level leakage resulting of device failure or reliability issues. The texturized film provides liquid resistance for the electrical apparatus.

The film with the textured surface can be formed with nanoparticles and can consequently be very thin. The film is virtually invisible and does not affect the performance of the electrical apparatus.

The underlying reasons for using the textured film may be different than the reasons for using a thick glob-top conformal coating. For example, when a glob-top coating is used, a thicker coating is generally better, because of greater physical protection or a physical barrier is provided with a thicker coating. In contrast, a thin film may act as a liquid repellant barrier. The thin film can be effective, even though it is scratched. The same is not true for other conformal films. Unlike a conformal coating, a thin textured film may not interfere with the electrical conductivity of a conductor, but it still protects the conductor from ionic solutions.

Textured films are particularly useful directly on electrical connectors. Current conformal coatings cannot be applied to electrical connectors since they are non-conductive and will increase the resistance between two conducting and contacting surfaces. However, a male connector and/or a female connector can be coated with the texturized films. Preferably both are coated. The texturized films can protect the connector surfaces from ionic contamination and shorts. If the female connector abrades the texturized film on the male connector (or vice-versa), the abraded texturized film would still protect conductors in the male connector from shorting out if the male connector is exposed to an ionic liquid such as water. The texturized films on the female and male connectors are thin enough so that the abrasion of either textured film can cut through the other film and provide for a low resistance connection. Low electrical resistance is desirable, since any increases in contact resistance can have a direct effect on the battery life and device performance of portable and low voltage electronic devices.

In addition, because some of the films disclosed herein may have reduced interference with electrical connections, rework may be significantly easier. With a glob-top coating, it may be necessary to locally (or globally) remove the coating prior to rework, and replace the coating after rework. With some of the films described herein, however, it may be possible to simply perform the rework without removing or replacing the film.

Because some of the films disclosed herein are significantly thinner than glob-top coatings, heat entrapment issues may be less.

Tests have shown that electronic devices (e.g., cell phones, PDA's or MP3 players) that use the texturized coatings can still function when they are immersed in electrolyte solutions. For example, flash memory drives (USB sticks) were coated with the texturized films using methods disclosed herein. The processed flash memory drives were tested by immersing them in Gatorade® (potassium phosphate+citric acid). A control sample shorted out in 2 seconds, while the test samples worked for up to 10 minutes while being immersed in Gatorade®.

As noted above, texturized films disclosed herein may be thin. They can be less than about 500 nm (typically at 100 nm). A coating may be about 1/250^{th} the thickness of a conventional parylene conformal coating.

Coatings with specific properties are provided. For example, a textured film may have one, two, or more of the following properties in Table 1. A variety of different methods may be used to make textured films with such properties. It is also possible to tune one or more of the properties (e.g., the physical abrasion characteristics or durability of a textured film).

TABLE 1

| | |
|---|---|
| Textured Roughness | 25 < RMS (nm) < 500 (Average roughness) |
| Textured Coverage | 25 < Coverage (%) < 60 (Average density) |
| Textured Durability | 10 < Force (micro-Newtons) < 5000 (or 500) |
| | (Force) |
| Thermodynamic | <70 (Zisman Critical angle) |
| Surface Energy | |

The composition of the textured film can vary. Since the conformal coating covers a conducting surface, a non-conducting material is generally used. Preferably, non-conducting particles are attached to a surface of a conductor such as a metal base (e.g., a copper line or copper pad). Suitable particles may comprise ceramics such as aluminum oxide, titanium oxide, silicon oxide, etc. The particles that form the textured film may also be organic latex spheres.

A textured film may be produced according to any suitable process. For example, the textured film can be created using a subtractive process (e.g., etching, creating pits, etc.) or an additive process. Preferred embodiments use additive processes to create the textured films.

Additive processes include liquid and vapor deposition processes. In a liquid deposition process, particles can be suspended in a liquid medium and can then be transported to the surface to be treated using a spray technique. In other embodiments, the textured film can be created using chemicals that react in a gaseous state or with chemically modified surfaces to create particles. The particles can then be transported to the surface to be treated by Van der Waals forces, gravity, or by fluid transport in a gas stream.

A textured film with a nano-structure can be created by a variety of methods, including dry and wet processing. One dry method is an atomic layer deposition reaction (ALD). Precursors for creating many materials via ALD are known to the art. For alumina, useful precursors include trimethylaluminum or TMA (Me₃Al), diethyl aluminum ethoxide (C₂H₅)₂AlOC₂H₂, and tris(diethylamino)aluminum. For silica, useful precursors include silicon tetrachloride (SiCl₄), Tretraethylorthosilicate (TEOS) (Si(OC₂H₅)₄) and disilane (Si₂H₆). For titania, useful precursors include Titanium Tretrachloride (TiCl₄) and tetrakis(dimethylamino)titanium (C₈H₂₄N₄Ti). Oxidizing agents such as ozone (O₃), oxygen plasma, or water vapor (H₂O) are often used in such ALD processes. ALD is used in many applications to obtain atomically smooth surfaces and/or coatings having an atomically uniform thickness, but can also be readily used to obtain rougher surfaces. (References: U.S. Pat. No. 6,426,4307. N. P. Kobayashi et al./Journal of Crystal Growth 299 (2007) 218-222, Sandia National Labs: LDRD Project 52523 Final Report, Atomic Layer Deposition of Highly Conformal Tribological Coatings—2005) CVD is used in many application can be used to create alumina nano-particles as noted by the work of Kim. (Reference: Kim et al, J. Material Engineering, (1991) 13:199-205) More generally, vapor flow-through technologies may be used as dry methods of creating textured film with a nano-structure.

Wet methods for obtaining a film with a nano-structure include applying a suspension of particles in a solution to a surface. Nanoparticles having specified properties can be commercially obtained from a number of sources. One such source is Nanophase Technologies Corp. of Romeoville, Ill., www.nanophase.com. Application methods for wet sprays can be obtained from many several commercially sources such as Asymtek (www.asymtek.com), PVA (www.pva.net) or Ultrasonic Systems (www.ultraspray.com)

Surface coverage requirements can also be taken into consideration. Textured film coverage on the surface to be treated can be controlled by controlling the flux of the various media, which creates the particles, and controlling the time of the particle flux. Rough surfaces may not be sufficient to provide protection for the printed circuit boards. In some instances, a device coated with a textured film had a rough surface as measured with an AFM (atomic force microscopy), but the device could still failed from an ionic (electrical) leakage.

The AFM technique for measuring roughness (RMS=root mean square) does not capture all relevant topographical information. In addition to a desired RMS roughness, a textured film preferably has a sufficiently wide coverage area on the surface to be treated. It is possible to define this as the “surface coverage” or “density” of the nano-particles in the textured film. In FIG. 2, three different cases provide the same RMS value of roughness, but the coverage needs to be greater than 6% (preferably greater than 20%) before the textured coating is deemed suitable for protecting the surface (in this application).

A textured film having porosity may be useful. It is believed that porosity in the textured film may help prevent fluids from reaching a protected surface by creating an air boundary layer between any liquid and the conducting surface. Porosity may be controlled via particle size and process parameters.

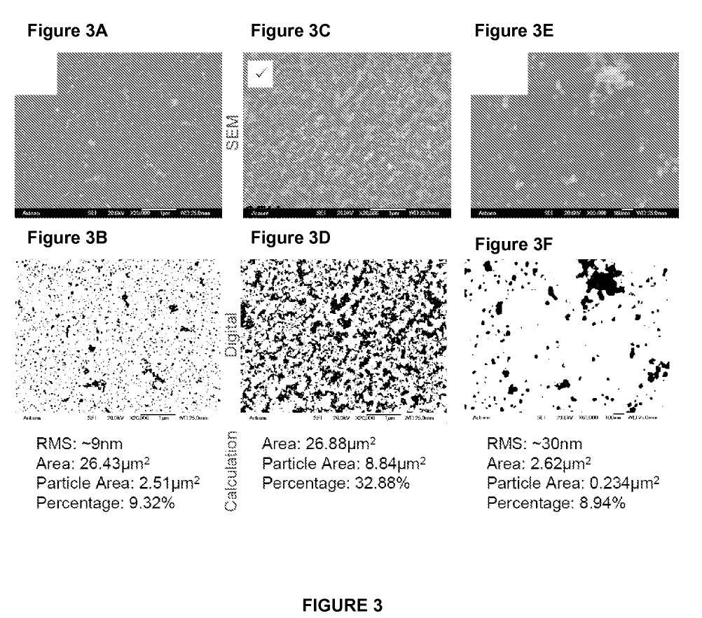

FIG. 2 shows a digital map that is used to calculate the surface coverage. As shown, specific surface coverage values can be desirable. FIG. 3 also shows additional surface coverage data.

In some embodiments, the particles in the textured film can be attached to a surface to be treated using a “glue.” The “glue” can provide the textured film with durability. Use of a “glue” type surface chemistry can bind particles together and can make the textured film more durable. The “glue” may be referred to as linker molecules or coupling agents. Preferred linker molecules include silanes with a reactive group at both ends. Suitable chemistries include the use of bi-functional linkers such as bis-trichlorosilane-ethane, bis-trichlorosilane-butane, bis-trichlorosilane-hexane, bis-trimethoxysilane-ethane, bis-trimethoxysilane-butane, bis-trimethoxysilane-hexane, bis-tris-dimethylaminosilane-ethane, bis-tris-dimethylaminosilane-butane, and bis-tris-dimethylaminosilane-hexane. Methoxy-ethoxy type linkers are particularly suitable for wet chemistry processes. Dimethyl-amines may be preferred in some situations over chloro-silanes, because the reaction product is a non-corrosive di-methyl-amine as opposed to HCl, which may be corrosive when exposed to water. Tetrachlorosilane is also a suitable linker.

Since the distance or geometric distance of the nano-particles in relation to each other can vary, and a combination of different linker chemistries can be used to improve durability (e.g., molecules of different lengths can be used to bind nano-particles together and/or to the surface to be treated). Durability is desirable, since the nano-particles in the textured film are preferably stable enough to adhere to the surface to be treated and also to each other. Some nano-particle based films are so porous or loosely bound that they self-disintegrate or dissolve with the slightest disturbance (e.g., a light air-stream). The durability of the texturized film can be controlled by controlling the exposure time of the chosen linking chemistry to particles which increases the number of binding sites between neighboring particles.

It is also possible to vary the gluing process. For example, a surface to be treated can be exposed to gluing chemistries, and the nanoparticles can be deposited thereon. In an alternative embodiment, the nano-particles themselves may be exposed to the gluing chemistries and the resulting intermediate product may then be bound to the surface to be treated.

Preferably, the nanoparticle may be pre-treated with protected linker molecules prior to deposition. A “protected” linker will not link with other nanoparticles or reacted to other surfaces during the deposition process. Then, after the pre-treated nanoparticles are deposited, the linker molecules may be deprotected, such that they link the nanoparticles to each other and to the surface. Examples of “protected” nanoparticle chemistries include pretreated particles with Isocyanates which can be deposited to the surface and then deprotected (or activated) using heat to form a urethane bond to the surface. In another chemical system, nanoparticles are treated with a surface chemistry containing Biotin and are reacted with Avidin terminations. Other possible protected binary reactions would include Epoxides and Amines.

In the case of electrical connectors in particular, the durability of the texturized films is preferably low enough so one electrical conductor can cut through the texturized film on the other conductor. This allows the electrical conductors of the connectors to contact each other and to electrically communicate with each other. Low resistance connections between conductors can increase the battery life of portable electronic devices and the like.

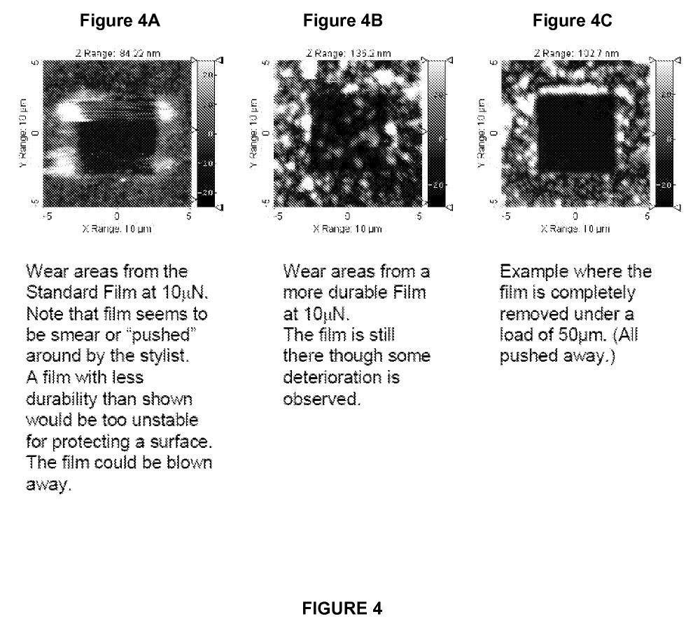

FIG. 4 illustrates the durability of texturized films using a Hysitron scanning probe. Here, the surface of an AFM probe tip is scrubbed against a texturized film with a known force. If the tested film is contacted with a force of about 10 μNewtons, then the film may not be stable enough. If the film is intact with a force with a force of 500 μN, then the film may be too durable to break through, depending on the specific application.

It is desirable to change the energy of the surface to be treated such that the critical energy is within a desired range, i.e., to provide a low surface energy coating. One way to do this is to expose the surface to be treated to long change hydrocarbons. Examples include but not limited to C8, C10, C11, C12, C14, and C18. Such long chain hydrocarbons may be derived from alkyl silanes (e.g., n-octyltriclohorosilane for C8). It is also possible to expose a surface to be treated to long chain fluorocarbons. Examples include FOTS FODCMS, or FDTS. Surface energy reduction can also be achieved with a wide variety of chemical treatments including the use of phosphonates or thiols. Alkyl-monomers and perfluoroalkyl monomers may be used to treat the surface, and may result in water contact angles greater than 135°. Ring structures, such as fluorinated or hydrogenated rings, may also be used like Pentafluorophenyl-trichlorosilane (C₉H₆F₅Cl₃Si).

Various methods may be used to apply materials to change the surface energy. One method is by the application of a self-assembling monolayer. Vapor application of a self-assembling monolayer is described in W. Robert Ashurst et al., Journal of MicroElectroMechanical Systems, Vol. 10, No. 1, March 2001 and W. Robert Ashurst et al., IEEE Transactions on Device and Materials Reliability, Vol. 3, No. 4, December 2003. See also R. Maboudian, Surface Science Reports, 30 (1998) 2007-269. Molecular Vapor Deposition (MVD®) of a self-assembling monolayer is described in B. Kobrin, et al., SEMI Technical Symposium: Innovations in Semiconductor Manufacturing (STS:ISM), 2004.

A preferred solution based process for forming a texturized film may include first obtaining alumina powder. Alumina powder can be produced or purchased from a supplier such as Nanophase Technologies. The alumina powder may have particle sizes of about 40-60 nanometers and may have a surface area of about 32-40 m²/gram.

After the alumina powder is obtained, about 40 mg of powder, for example, can be dispersed in 10 ml of methanol. An ultrasonic process can be used to ensure complete dispersion. Once dispersed, the solution can be sprayed onto a substrate to be treated at about 80° C. using a spray bottle or other spraying apparatus. Additional dilution of the stock solution with methanol or other solvent may be used to help control the thickness of the overall textured film being deposited. The resulting roughness of the film can be about 25 rms (nm), with coverage estimated at 25%. To improve the durability of the textured film, the surface to be treated can be exposed to bis-chlorosilane-ethane (vapor), before, after, or while the alumina particles are attached to the surface. The surface energy can be changed by exposing the surface to be treated with FDTS (vapor) or by a 0.5% solution of C18 in iso-octane.

A preferred vapor deposition process can use a vapor deposition chamber. Process conditions can include heating TMA to 50° C., which results in about 42 T of vapor pressure. Then, water is heated to 40° C., and a needle valve is adjusted so that the vapor pressure is about 55 Torr. Then, the substrate to be treated is exposed to the vapor of water and TMA sequentially for 15 seconds using an N₂ carrier gas (used in part for dilution). This water followed by TMA exposure can be repeated to increase the thickness. Then, the nano-particles are exposed to bis-chlorosilane-ethane (vapor) using a carrier gas. The injection process can be conducted for 30 seconds. Then, the surface energy can be changed with exposure to FDTS or FODCMS (vapor) using a carrier gas, again for 1 minute. Exposure to bis-chlorosilane-ethane increases the durability of the film as more links are created between the nano-particles.

In an alternative method for making the texturized film, it is possible to spray or shower the surface of a substrate with nano-particles. The nano-particles embed in the surface and dry leaving the desired texture (i.e., sand-blast roughening of the surface.). A low surface energy coating is applied to the circuit board. Other process variations include the use of other linker chemistries such as those listed above.

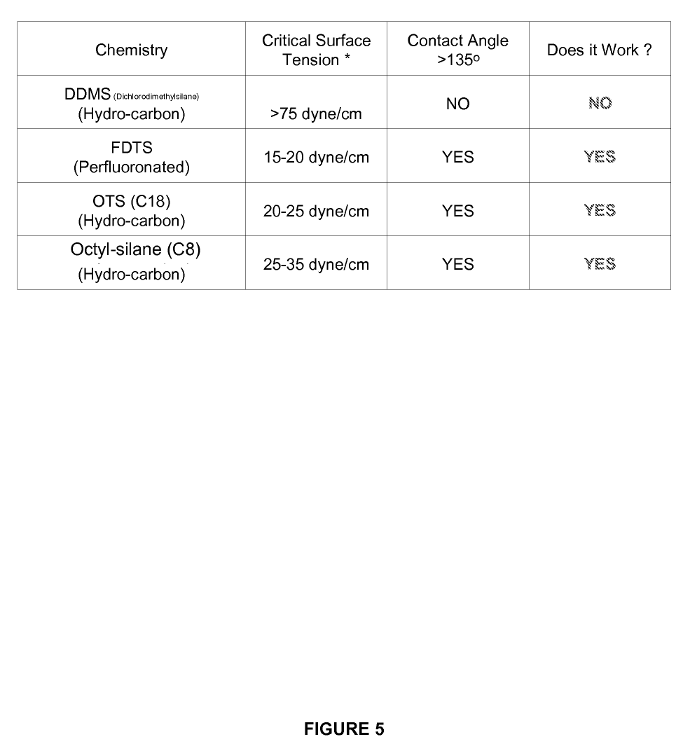

Other chemistries can be used to lower the surface energy of a surface. Examples are provided in FIG. 5.

A textured surface preferably has one or more, and preferably all, of the following properties:

| | |
|---|---|
| a) Film Roughness: | 25 < RMS (nm) < 500 (Average roughness) |
| b) Film Coverage: | 25 < Coverage (%) < 60 (Average density) |
| c) Film Durability: | 10 < Force (μ-Newtons) < 500 (Force) |
| d) Surface Energy: | 0 < Energy (Dyne/cm) < 70 (Zisman Critical angle) |

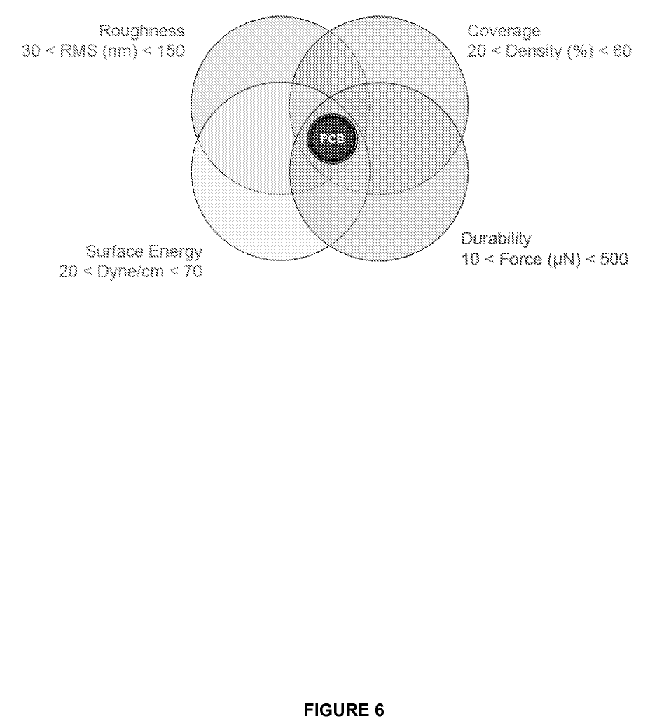

FIG. 6 graphically shows other ranges for the four textured film properties described above, when used to protect a printed circuit board or other type of electrical apparatus.

The film can have a thickness that is less than about 5000 Å or less than about 5 microns, and the film can be used to protect printed circuit boards and other electrical assemblies from ionic contamination.

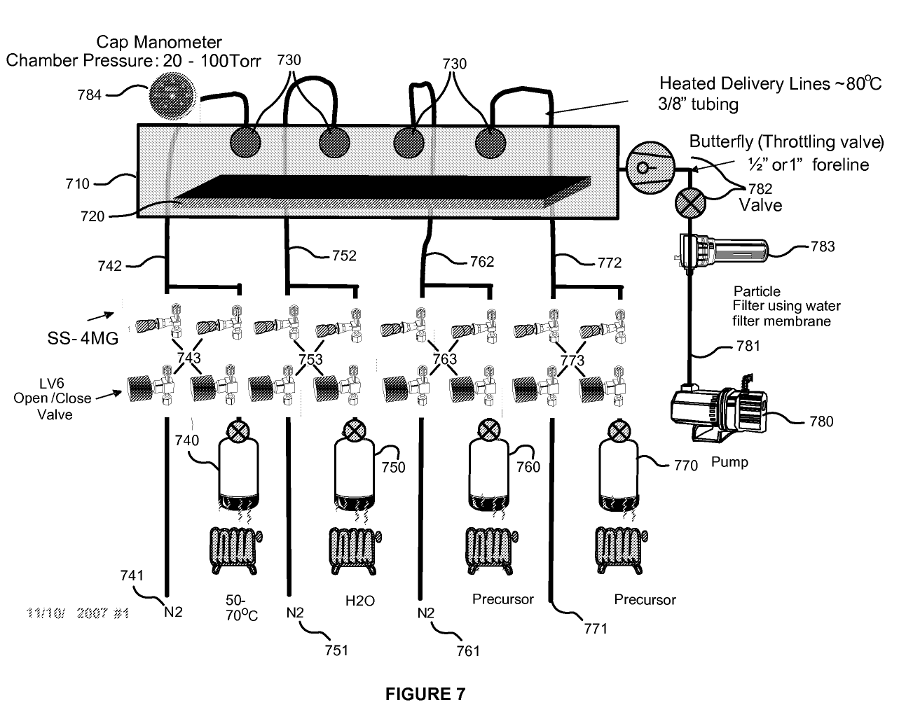

FIG. 7 shows an apparatus that may be used to fabricate coatings. Other apparatus may also be used. The apparatus includes a chamber 710. A substrate holder 720 and gas dispersion rods 730 are disposed within the chamber. Gas dispersion rods 730 are connected to various material sources through valves and tubes. The material sources may be heated. A heated stainless steel cylinder containing the precursor source 740, and a source of nitrogen carrier gas 741 are connected to a gas dispersion rod 730 by tubes 742 and valves 743. A heated water source 750, and a source of nitrogen carrier gas 751 are connected to a gas dispersion rod head 730 by tubes 752 and valves 753. A heated first precursor source 760, and a source of nitrogen carrier gas 761 are connected to a gas dispersion rod 730 by tubes 762 and valves 763. A heated second precursor source 770, and a source of nitrogen carrier gas 771 are connected to a gas dispersion rod 730 by tubes 772 and valves 773. The specific material sources illustrated in FIG. 7, including the carrier gas source, are by way of example, and other material sources may be substituted or added. A vacuum pump 780, in conjunction with tubes 781, valves 782, filter 783 and manometer 784 are also connected to chamber 710, and may be used to control the pressure within chamber 710 and to remove reaction byproducts and excess reagents from chamber 710. The apparatus of FIG. 7 is particularly well suited for wet methods for obtaining a film with a nano-structure.

A coating may be fabricated by placing a substrate, including an electronic device or the like, to be coated on substrate holder 720. The substrate may be exposed to various materials in desired combinations and/or sequences in a controlled manner by operating the valves of the apparatus of FIG. 7.

An in-line continuous spray system may also be used for wet methods for obtaining a film with a nano-structure. In that type of system, a substrate on a conveyor apparatus is passed sequentially under a number of shower heads or similar spray apparatus, and is exposed to different materials or combinations of materials by each shower head. Commercial spray coating equipment is available for Asymtek (www.asymtek.com), (www.asymtek.com), PVA (www.pva.net) or Ultrasonic Systems (www.ultraspray.com).

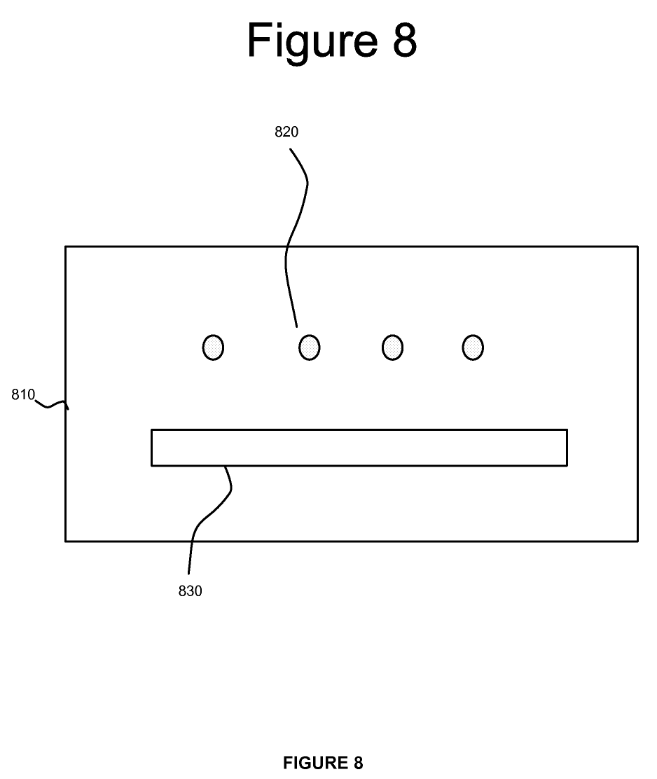

FIG. 8 shows an apparatus that may be used to fabricate coatings. Other apparatus may be used. The apparatus includes a chamber 810. Chamber 810 includes inlet tubes 820 through which gas may be introduced into chamber 810. Inlet tubes 820 may be connected to various material sources using connections know to the art. Chamber 810 may be subjected to a vacuum using apparatus and techniques known to the art. The apparatus of FIG. 8 is particularly well suited for vapor deposition methods for obtaining a film with a nano-structure.

Some desirable terms may include the following.

As used herein, a layer described as “over” another layer allows for the possibility of intervening layers, and a layer described as “on” another layer does not allow for intervening layers.

Film coverage definition: using a digital map to represent the surface topography and surface density. As quantified herein for purposes of defining which films have sufficient coverage, a digital map similar to that shown in FIG. 2 may be generated for any given surface. These areas are shown, for example, as black in FIG. 2. Thus, a surface having few large protrusions may have a surface roughness similar to that of a surface having many smaller protrusions, but the surface with many smaller protrusions may have a significantly greater coverage, as illustrated in FIG. 2.

IMAGE.J Software (versions 1.38) was used for computing the digital surface coverage. ImageJ is a public domain, Java-based image processing program developed at the National Institutes of Health and is available on the internet. The source code has been published by the NIH.

The following procedure was used to compute the digital surface coverage.
1) Take the SEM image
2) Open the image file in Image J software
3) Set scale in Image J to match with scalebar (this allows for calculation of sizes in actual physical units, as opposed to pixels)
4) Convert the image to binary. The surface roughness now shows as black . . . everything else is white.
5) Select the region of the image that includes everything above the scale bar (including the scale bar will cause erroneous calculations). Analyze the area—this represents the total surface area (Call this number “A”)
6) Analyze particles, from 0 to infinity size. This counts all particles, and calculates their individual areas. Copy and paste the results into Excel.
7) Add up all the areas of the particles. Call this number “B”
8) “B/A” represents the fraction of the total surface that is occupied by particles.
9) The threshold is set using the publish Isodata Algorithm [T. W. Ridler, S. Calvard, Picture thresholding using an iterative selection method, IEEE Trans. System, Man and Cybernetics, SMC-8 (1978) 630-632.] which is included in the version 1.38 software package. In the Isodata Algorithm, the procedure divides the image into objects and background by taking an initial threshold, then the averages of the pixels at or below the threshold and pixels above are computed. The averages of those two values are computed, the threshold is incremented and the process is repeated until the threshold is larger than the composite average.

Film Durability: The film is subjected to testing in a Hysitron scanning probe. A pyramid-shaped Berkovich probe tip having a 150 nm radius with a controlled reciprocating scratch with 100 cycles, a length of 3 μm, at a rate of four seconds is applied to the film. The normal load for these tests was 10 to 500 μN. A profile map of the scanned area shows if the film is still present or is removed. Films which were removed with a 10 μN load were observed to lack coherence. These films could be easily removed or “blown away” or would be removed by gravity. Films which were still present with a 500 μN force are very durable and would not be removed from a connector surface under normal contact pressures which would lead to electrical conduction issues.

This texturized surface or conformal coating can include any non-conductive material. Such materials include metal oxides such as (aluminum oxide, titanium oxide, and silicon oxide). Other materials may include organic latex spheres or other media. A conformal coating with the above-described properties can suppress electrical leakage from circuit leads by creating an ionic barrier.

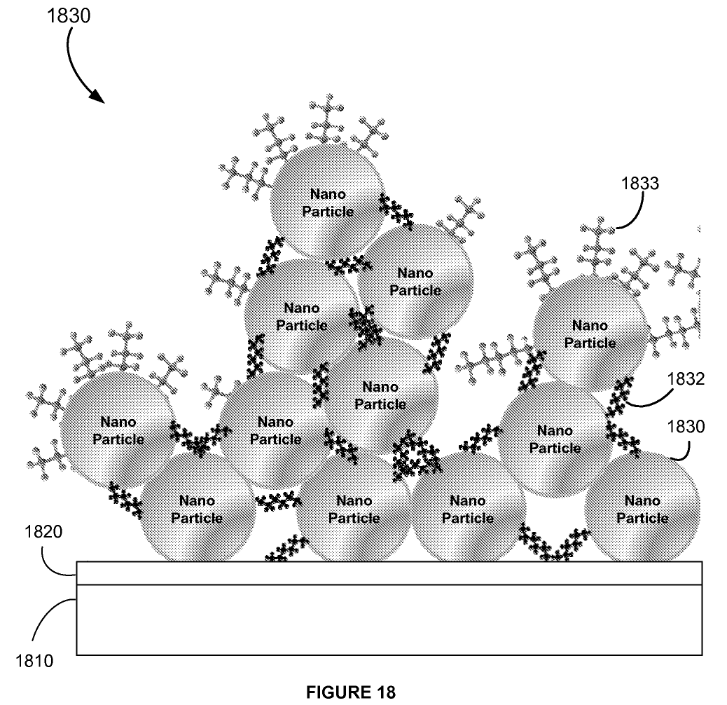

FIG. 18 shows a dual layer corrosion barrier. The structure is similar to that shown in FIG. 1, but there is a VCI layer disposed between the substrate and the anti-wetting barrier. VCI layer 1820 is disposed on substrate 1810. Anti wetting barrier 1830 is disposed on VCI layer 1820. Anti-wetting barrier 1830 includes nanoparticles 1831 that are linked to each other and to VCI layer 1820 by linker molecules 1832. Low surface energy coating 1833 is disposed over nanoparticles 1831 and linker molecules 1832. Collectively, VCI layer 1820 and anti-wetting barrier 1830 form a dual layer corrosion barrier.

Examples 12 and 13 show that a VCI layer alone does not protect against exposure to liquid, whereas an anti-wetting barrier, either alone or in conjunction with a VCI layer, does protect against exaposure to liquid.

The description herein is illustrative and is not restrictive. Many variations will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

### Experimental

For a Vapor deposition coating process: Nano-particles were created using chemical reactions which consist of two self-limiting process steps. The use of sequential chemical reactions ensures the proper reaction at the surface. For alumina particles, the overall reaction is.

2Al(CH₃)₃+3H₂O→Al₂O₃+6CH₄

The two self-limiting process steps, which are surface reactions, are:

2AlOH+2Al(CH₃)₃→2[Al—O—Al(CH₃)₂]+2CH₄ Surface Reaction #1:

2[Al—O—Al(CH₃)₂]+3H₂O→Al₂O₃+2AlOH+4CH₄ Surface Reaction #2:

To impart durability into the film, a bi-functional linker is applied to the particles. By introducing more linking agents, the cohesion between the nano-particles is increased. To impart super-hydrophobic qualities to a surface, we then apply an organosilane-based self-assembled monolayer (SAM) that forms a covalent bond nano-structure.

An example of an ALD process recipe is shown below in Table 3. The value of “1” indicates that the valve in the corresponding vacuum diagram (FIG. 7) is open.

TABLE 3

| | | | | | | | | | | | Slow | | |
|---|---|---|---|---|---|---|---|---|---|---|---|---|---|
| Note | Step | Time | Gas 1 | N2 1 | Gas 2 | N2 2 | Gas 3 | N2 3 | Gas 4 | N2 4 | ISO | ISO | Vent |
| Pump Down | 1 | 60 | | | | | | | | | | 1 | |
| Particle-Set-Up #1 | 2 | 5 | | 1 | | | | | | | | 1 | |
| Water Injection | 3 | 15 | 1 | 1 | | | | | | | | | |
| Purge #1 | 4 | 10 | | 1 | | | | | | | | 1 | |
| Metal Precursor Setup | 5 | 5 | | | | | | 1 | | | | 1 | |
| TMA Injection | 6 | 15 | | | | | 1 | 1 | | | | | |
| React #1 | 7 | 15 | | | | | | 1 | | | | 1 | |
| Particle-Set-Up #2 | 8 | 5 | | 1 | | | | | | | | 1 | |
| Water Injection | 9 | 15 | 1 | 1 | | | | | | | | | |
| Purge #2 | 10 | 10 | | 1 | | | | | | | | 1 | |
| Metal Precursor Setup | 11 | 5 | | | | | | 1 | | | | 1 | |
| TMA Injection | 12 | 15 | | | | | 1 | 1 | | | | | |
| React #2 | 13 | 15 | | | | | | 1 | | | | 1 | |
| Linker Treatment | 14 | 5 | | | | 1 | | | | | | 1 | |
| Linker Chemistry Injection | 15 | 30 | | | 1 | 1 | | | | | | | |
| Purge #4 | 16 | 10 | | | | | | | | | | 1 | |
| Reaction | 17 | 60 | | | | | | 1 | | | | 1 | |
| Set-Up Surface Treatment | 18 | 5 | | | | | | | | 1 | | 1 | |
| Surface Treatment Injection | 19 | 60 | | | | | | | 1 | 1 | | | |
| Reaction | 20 | 60 | | | | | | | | | | | |
| Purge | 21 | 30 | | | | | | | | | | 1 | |
| Chamber Vent | 22 | 260 | | | | | | | | | | | 1 |

Alternatives to the process include increasing or decreasing the times of the chemical injection times. The water injection time (Step#3 and Step #9 in the above Table) can vary from 1 to 30 seconds. The TMA or precursor injection time (Step #5 and Step #12) can vary from 1 to 30 seconds. The purge times (Step#4, Step#10, Step#16, Step #21) can be increased to decreased to control the mixing of the residual vapors. As the purge time is increased, the concentration of the adsorbed vapors onto the surface is reduced which reduces the surface reactions and the number of nano-particles. The above reaction was performed at pressure between 1 torr to 100 torr. The temperature of the reaction was performed at 35C. By controlling the temperature, pressure, time, and the timing sequence, the size and number of nano-particles can be influenced. The timing and order of the linker chemistry injection will affect the durability of the nano-composite produced.

For a wet spray process: Alumina oxide particles with a surface area of 3-5 meter²/gram and with a particle size distribution between 40 to 60nm were commercially purchased. A solution of consisting of 40 mg of alumina powder was added to 10 ml of methanol. The solution was sonicated to insure complete dispersion. The solution was sprayed onto the substrate@80° C. using a artist airbrush. Additional dilution of the stock solution with methanol or other solvent can help control the thickness of the overall textured film being deposited. Improve durability with exposure to Bis-Chlorosilane-ethane (vapor). Change surface energy with exposure to FDTS (vapor) or C18 in a solution of iso-octane or hexane.

### EXAMPLE 1

In FIG. 4A, the recipe shown in Table-3 using steps 1 through 13, 18 through 22 were used. The surface treatment chemistry in Step #19 was FDTS. A wear load of 10 μN was applied. The AFM image shows that the nano-particles (texture) were pushed around indicating the particles were loosely coherent or just laying on the surface. In FIG. 4B, the deposition recipe shown in Table-3 using steps 1 through 22 were used. The linker chemistry in Step #15 was Bis-trichlorosilane-Ethane and the surface treatment chemistry in Step #19 was FDTS. A wear load of 10 μN was used. The nano-particles were adherent of the surface and were not pushed around by the loaded stylist. In FIG. 4C, the recipe shown above using steps 1 through 22 were used expect the wear load was increased to 50 μN. The process recipe used for FIG. 4B was used. The nano-film was completely removed.

### EXAMPLE 2

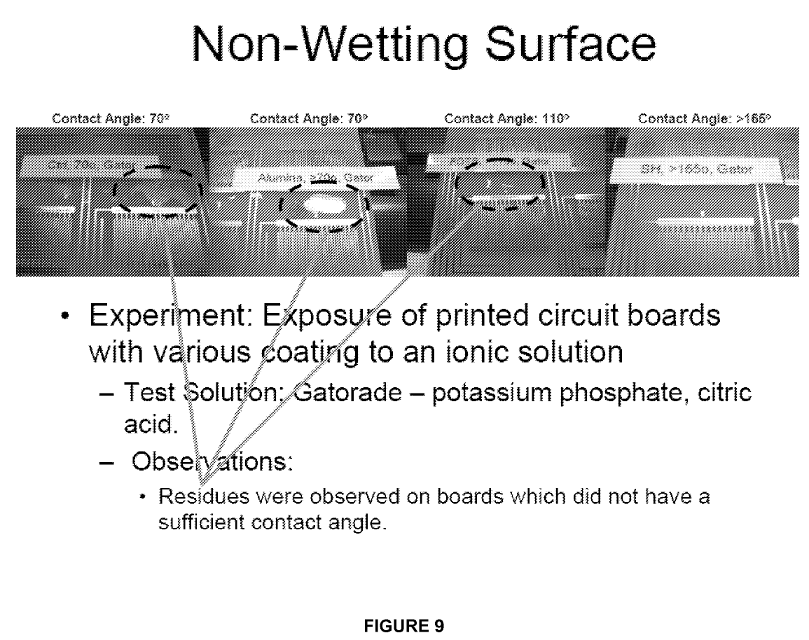

A printed circuit board with various coatings are shown in FIG. 9. The circuit boards consists of an inter-digitated comb structures specifically designed for testing reliability after a high temperature bake. The test boards were exposed to Gatorade®, which is an ionic solution that includes potassium phosphate and citric acid. The contact angle of the Gatorade® on each coating was measured by using a Rame-Hart Goniometer. Contact angles were as follows: Example 1A, 70°; Example 1B, 70°; Example 1C, 110°; Example 1D, >165°.

### EXAMPLE 2A

A printed circuit board of Example 2 shown in FIG. 9 consists a inter-digitated comb structures used for testing reliability was provided, without any treatment. When the board is exposed to Gatorade®, the surface wets and dries with a potassium phosphate/sugar residue. These residues result in leakages between the inter-digitated surface wiring of the printed circuit board.

### EXAMPLE 2B

The printed circuit board of Example 2 was coated with alumina particles having a diameter of approximately 40 to 60 nm. The coating was performed via by a process of TMA and Water with a recipe shown in Table 3 using steps 1 through 13. The contact angle of a Gatorade® solution was ˜70 degrees. The solution adheres to the surface and dries with a residue.

### EXAMPLE 2C

A printed circuit board similar to Example 2A but subsequently coated with a hydrophobic coat of FDTS (Step #19) with a recipe shown in Table-3 using steps #18 through #22. The contact angle of a Gatorade® solution was ˜110 degrees. The Gatorade® solution would “bead-up” in clumps but when dried, residues were still observed.

### EXAMPLE 2D

The printed circuit board Example 2A was further treated by applying alumina particles using a CVD reaction of TMA and Water (Table#3, Steps #1 to Step#13) followed by a surface treatment of FDTS (Steps #18 to #22). The Gatorade( contact angle was >165 degrees. The surface does not wet and no residues were observed. No electrical leakage could be measured using a resistance Ohm meter.

### EXAMPLE 3

Several samples were prepared by depositing alumina particles over a 50×50 micron square and then treating with FODCMS. These samples show how surface roughness and low surface energy add to anti-wetting properties and ionic contamination control.

### EXAMPLE 3A

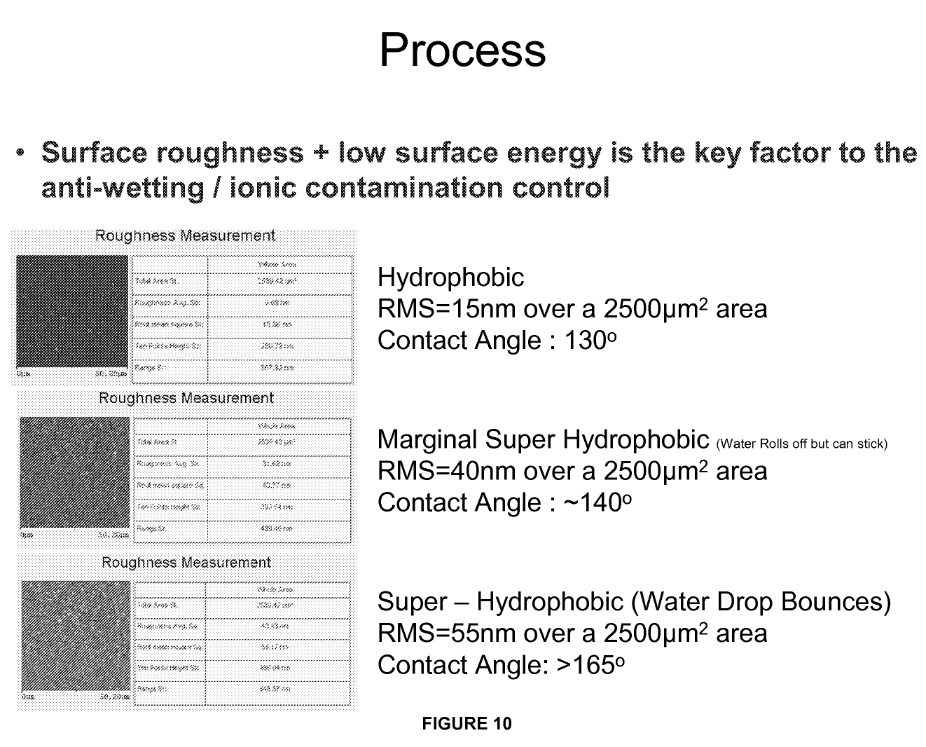

Alumina particles having a diameter of 40 to 60 nm were deposited over a Silicon substrate by a recipe shown in Table 3. BCTSE was used as the linker agent in Step #15 and FODCMS was used as a low surface energy coating in Step#19. The resultant film is illustrated in FIG. 10A, and was measured as having an average roughness of 9.63 nm., an RMS roughness of 15.66 nm and a ten points height of 280.72 nm. A water contact angle of 130° was observed.

### EXAMPLE 3B

A sample was prepared using a method similar to that of Example 3A, except the water injection time was increased two times. The resultant film is illustrated in FIG. 10B, and was measured as having an average roughness of 31.62 nm., an RMS roughness of 40.77 nm, and a ten points height of 393.54 nm. A water contact angle of 140° was observed. As the surface roughness increases, the contact angle increased.

### EXAMPLE 3C

A sample was prepared using a method similar to that of Example 3A, except the water injection was increased 4 times. The resultant film is illustrated in FIG. 10C, and was measured as having an average roughness of 43.43nm., an RMS roughness of 55.17 nm, and a ten points height of 485.04 nm. The water contact angle of >165° was observed. When the surface roughness increased further, the anti-wetting properties were observed.

### EXAMPLE 4

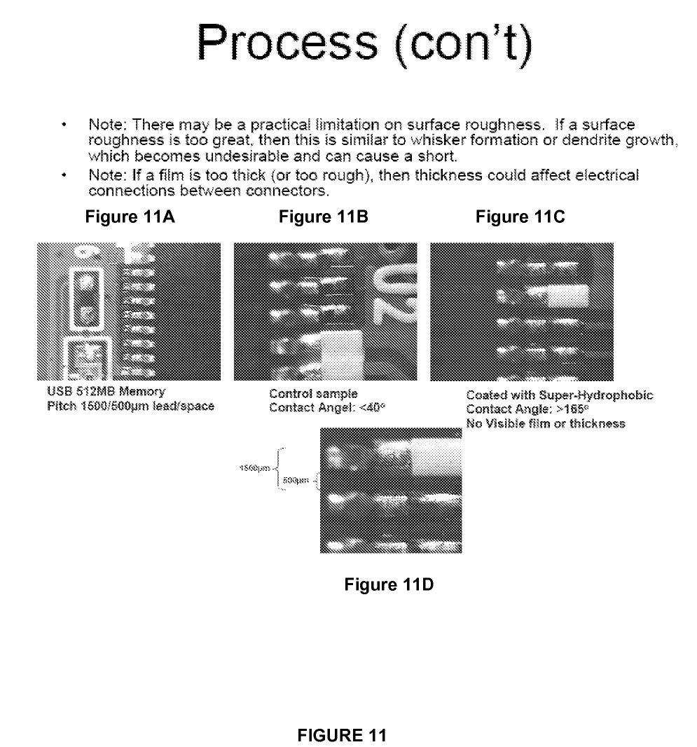

Example 4 shows a USB 512 MB memory, both uncoated and coated. FIG. 11A shows the USB 512 MB memory having a 1500 micron pitch and 500 micron spacing between the leads. If the film thickness plus the film's roughness is greater than ½ the distance between the spacing, there is a potential for electrical shorting. Thus the film thickness is preferably much less than the spacing between the minimum features size.

### EXAMPLE 4A

Gatorade® was applied to the USB 512 MB memory as received. A water contact angle of <40° was measured. FIG. 11B shows the uncoated USB 512 MB memory at a greater magnification than that of FIG. 11A. Gatorade® completely wets the electrical circuit and any residuals between the electrical leads from a drying solution could potential cause leakage pathways.

### EXAMPLE 4B

A USB 512 MB memory was treated per the recipe of Table 1 Steps#1 to 22. The linker chemistry in Step #15 was Bis-trichlorosilane-ethane and the surface treatment chemistry in Step #19 was FDTS. The alumina nano-particles were ˜40 μm-60 μm in size. A water contact angle of >165° was measured. FIG. 11C shows the coated USB 512 MB memory at the same magnification as that of FIG. 11B. The coating is not visible. No liquids were observed to adhere to the surface and accumulated on the surface or between electrical leads.

### EXAMPLE 5

Several samples were prepared, each using the same alumina particles, linker molecules, and low surface energy coating. The linker chemistry was Bis-Trichlorosilane-ethane and the surface treatment chemistry was FODCMS. The differences were in the parameters used to deposit the alumina particles, resulting in different surface roughnesses.

### EXAMPLE 5A

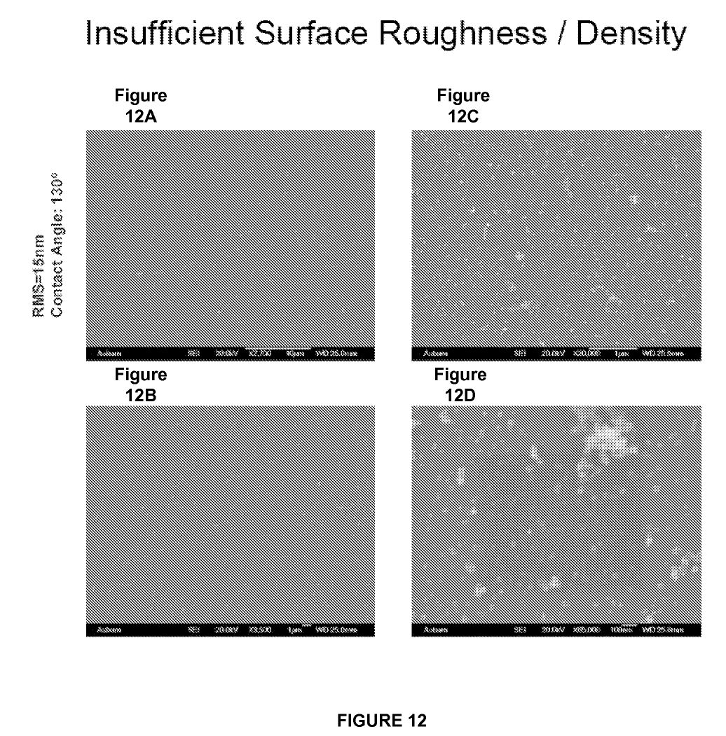

The deposition parameters were similar to Table 3. The result is shown in FIG. 12, and has a RMS surface roughness of 15 nm. A water contact angle of 130° was observed. FIGS. 12A, 12B, 12C and 12D are the same sample at different magnifications, ×2,700, ×3,500, ×20,000 and ×65,000 respectively.

### EXAMPLE 5B

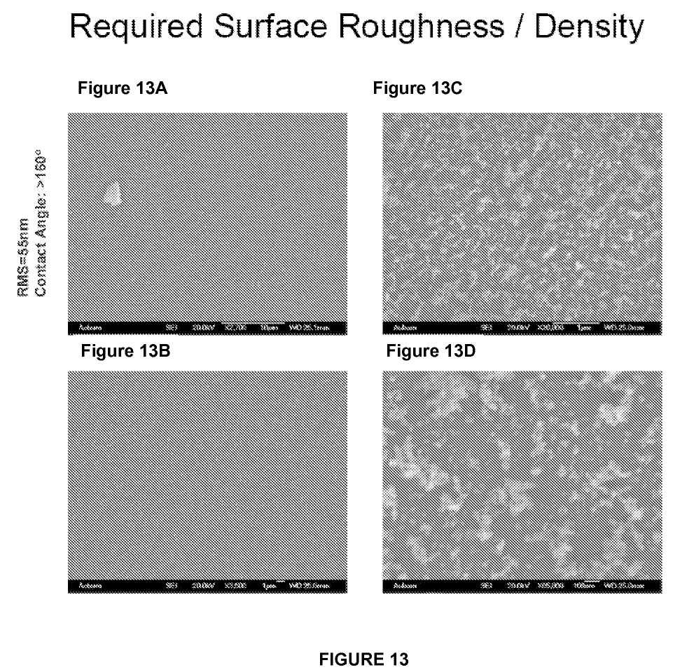

The deposition parameters were similar to Table 3 but the water vapor injection time during the coating process was increased by 2 times. The result is shown in FIG. 13, and has a RMS surface roughness of 55 nm. A water contact angle of >1600 was observed. FIGS. 13A, 13B, 13C and 13D are the same sample at different magnifications, ×2,700, ×3,500, ×20,000 and ×65,000 respectively. The increased surface roughness and density can be observed.

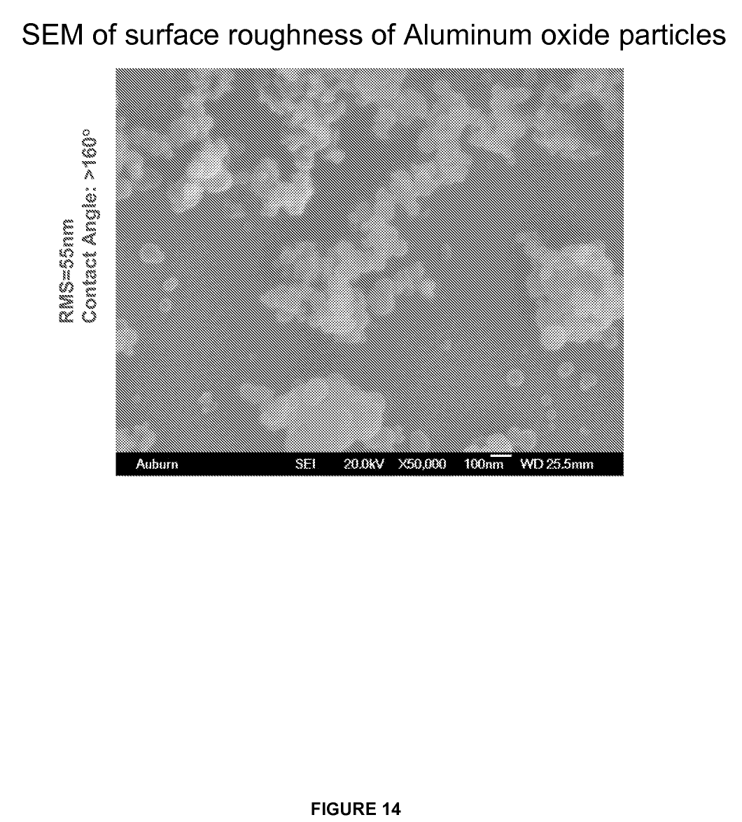

FIG. 14 shows a scanning electron micrograph (SEM) of a cross section of a sample similar to that illustrated in FIG. 13.

### EXAMPLE 6

Critical surface tension was measured from four (4) different surface coatings used to reduce the surface energy. The measurement was performed by depositing a layer of the material on a polished silicon surface. Table 2 shows the results. The “Contact Angle” was measured using DI water. The contact angle was also measured on alumina particles and measured it the resulting contact angle was greater than 135degrees. It was observed that if the critical surface tension was >75 Dyne/cm, a contact angle greater than 135 degrees could not be achieved and the film did not exhibit an ionic barrier.

TABLE 2
SURFACE ENERGY WITH ROUGHNESS

| | Critical | Contact | Does it |
|---|---|---|---|
| Chemistry | Surface Tension* | Angle > 135° | Work? |
| DDMS | >75 dyne/cm | NO | NO |
| (Dichlorodimethylsilane) | | | |
| (Hydro-carbon) | | | |
| FDTS | 15-20 dyne/cm | YES | YES |
| (Perfluoronated) | | | |
| OTS (C18) | 20-25 dyne/cm | YES | YES |
| (Hydro-carbon) | | | |
| Octyl-silane (C8) | 25-35 dyne/cm | YES | YES |
| (Hydro-carbon) | | | |

*Critical Surface Tension measured on polished silicon surface

### EXAMPLE 7

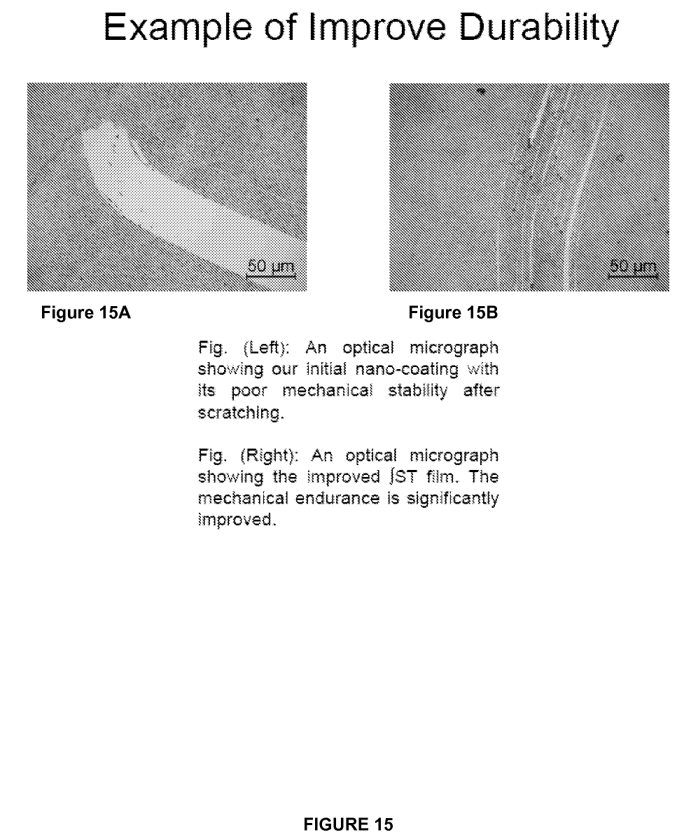

A protective film was formed by a wet process as shown in FIG. 15.

First, a silicon substrate was sprayed with a mixture of alumina particles about 40 nm in diameter, suspended in methanol and water, 0.5 wt % alumina in a solution of 1000 (volume) methanol:100 (volume) water. The surface was heated to 80° C. during the spray using an artist airbrush. The surface in FIG. 15B was subsequently treated with Bis-trichlorosilane-ethane vapor coating followed by C18 in a solution. The final surface had a RMS surface roughness of 25 nm, and a contact angle of about 135° for water.

### EXAMPLE 8

Films with improved durability were formed by exposing the nano-particles to a linker chemistry.

### EXAMPLE 8A

A film was formed by a process similar to Example 7. The film was subjected to a mechanical scratch test by sliding the surface of Teflon tweezers over the substrate. The result is illustrated in FIG. 15A, showing that the film was removed where scratched.

### EXAMPLE 8B

A film was formed using a process similar to that of Example 8A, except nano-particles are exposed to Bis-Trichlorosilane-Ethane after the formation of the nano-particles onto the surface and before the surface treatment. The film was subjected to the same scratch test described in Example 8A. The result is illustrated in FIG. 15B, showing an improved film durability.

### EXAMPLE 9

A sample was prepared using a method similar to that described in Table 3.

### EXAMPLE 9A

The resultant film is illustrated in FIG. 3A (a SEM photograph) and FIG. 3B (a digitized image showing black where film roughness protrudes from the surface. The film had a RMS roughness of 9 nm. Based on FIG. 3B, the film has a coverage of 2.51 μm² over an area of 26.43 μm², for a film coverage of 9.32%. This coating did not exhibit ionic barrier properties.

### EXAMPLE 9B

The resultant film is illustrated in FIG. 3C (a SEM photograph) and FIG. 3D (a digitized image showing black where the film roughness protrudes from the surface. The film had a RMS roughness of 35 nm. Based on FIG. 3D, the film has a coverage of 8.84 μm² over an area of 26.88 μm², for a film coverage of 32.88%. This coating does exhibit ionic barrier properties.

### EXAMPLE 9C

The resultant film is illustrated in FIG. 3E (a SEM photograph) and FIG. 3F (a digitized image showing black where the film roughness protrudes from the surface. The film had a RMS roughness of 30 mm. Based on FIG. 3F, the film has a coverage of 8.94 μm² over an area of 26.62 μm², for a film coverage of 8.94%. This coating does not exhibit the ionic barrier properties.

### EXAMPLE 10A

A film was formed by the recipe shown in Table 3 using steps 1 through 13, 18 through 22 were used. The water injection time in Step#3 and Step#9 was 30″ and surface treatment chemistry in Step #19 was FODCMS.

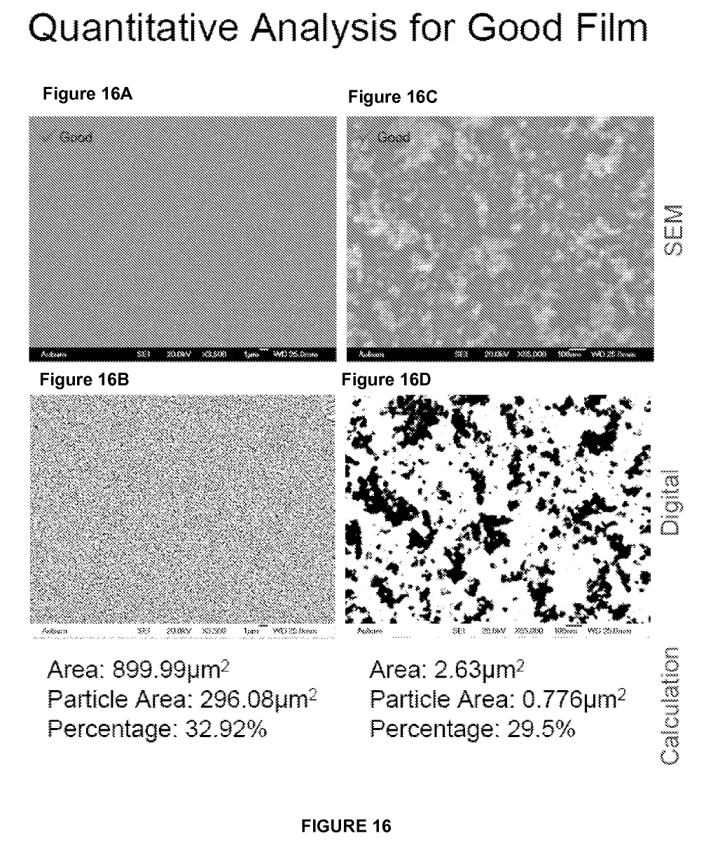

The resultant film is illustrated in FIG. 16A (a SEM photograph) and FIG. 16B (a digitized image showing black where the film roughness protrudes from the surface. The film had a RMS roughness of ˜50 nm. Based on FIG. 16A, the film has a coverage of 296.08 μm² over an area of 899.99 μm², for a film coverage of 32.92%.

### EXAMPLE 10B

In FIG. 16B, the digital image of the SEM photograph is shown which is converted to have a coverage of 296.08 μm² over an area of 899.99 μm², for a film coverage of 32.92%.

A higher resolution SEM of the same sample in FIG. 16A is shown in FIG. 16C. In FIG. 16D (a digitized image showing black where the film roughness protrudes from the surface). The film had a RMS roughness of ˜50 nm Based on FIG. 16D, the film has a coverage of 0.776 μm² over an area of 2.63 μm², for a film coverage of 29.5%. This illustrates that the IMAGEJ digital conversion process is independent of the magnification.

### EXAMPLE 11A

A film was formed by the recipe shown in Table-3 using steps 1 through 13, 18 through 22 were used. The surface treatment chemistry was FDTS in Step #19.

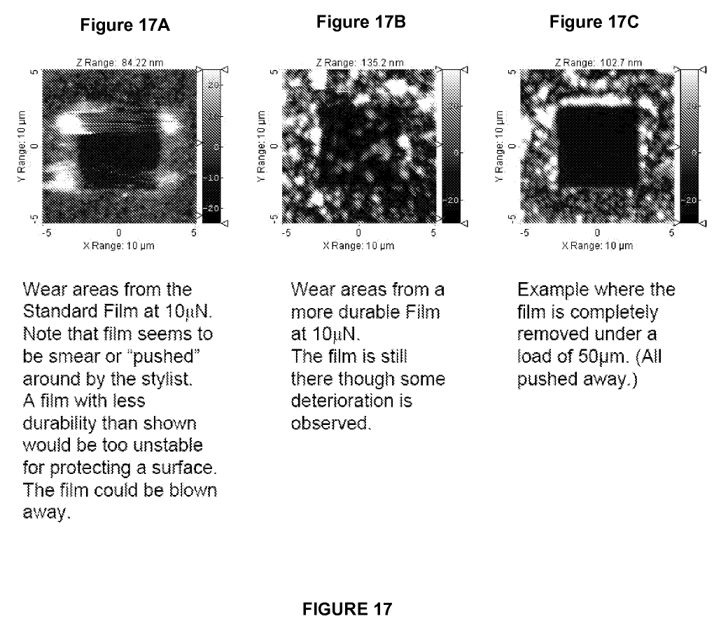

The resultant film was subjected to durability testing using a Hysitron scanning probe. The film was subject to scrubbing from the scanning probe with a force of 10 μN. A pyramid-shaped Berkovich probe tip having a 150 nm radius with a controlled reciprocating scratch with 100 cycles, a length of 3 μm, at a rate of four seconds is applied to the film. The result is shown in FIG. 17A. The film was almost entirely removed in the area subjected to testing.

### EXAMPLE 11B

A film was formed by the process of EXAMPLE 11A using steps #1 through step #22. The linker chemistry used in Step #15 was Bis-Trichlorosilane-ethane.

The resultant film was subjected to the same testing as that of Example 11A. The result is shown in FIG. 17B. While some deterioration is observed in the tested area, the film is still intact.

### EXAMPLE 11C

A film was formed by the process of EXAMPLE 11A using steps #1 through step #22. The linker chemistry used in Step #15 was Bis-Trichlorosilane-ethane.

The film was subject to the same testing as that of Example 11A, but the applied pressure was 50 μmN. The result is shown in FIG. 17C. The film was entirely removed in the area subjected to pressure.

### EXAMPLE 12

Sheets of copper were subject to various surface treatments.

Sample 12A was not treated.

Sample 12B was coated with a VCI. The VCI was applied by preparing a solution of 1% BTA in isopropyl alcohol (IPA). The copper sheet was immersed in the solution for 15 seconds. The copper sheet was then rinsed with IPA and dried. Sample 12B was not further treated.

Sample 12C was coated with an anti-wetting barrier, but no VCI. The anti-wetting barrier was applied using the process described in Table 4, steps labeled “Nano-Particles” and subsequent steps.

TABLE 4

| | Note | Time | G1 | N₂1 | G2 | N₂2 | G3 | N₂3 | G4 | N₂4 | ISO | N₂5 |
|---|---|---|---|---|---|---|---|---|---|---|---|---|
| VCI | Start in | 0.25 | | | | | | | | | | |
| | safe state | | | | | | | | | | | |
| | Pump line | 20 | | | | | | | | 1 | 1 | |
| | purge | | | | | | | | | | | |
| | Purge lines | 20 | | 1 | | 1 | | 1 | | | | |
| | #2 | | | | | | | | | | | |
| | Pump | 60 | | | | | | | | | 1 | |
| | before | | | | | | | | | | | |
| | process | | | | | | | | | | | |
| | Transition | 0.25 | | | | | | | | | | |
| | Set up G4 | 0.25 | | | | | | | | | | |
| | G4 | 60 | | | | | | | 1 | | | |
| | injection | | | | | | | | | | | |
| | G4 purge | 5 | | | | | | | | 1 | | |
| | Reaction | 120 | | | | | | | | | | |
| | Blow out | 5 | | 1 | | 1 | | 1 | | 1 | 1 | |
| | Pump out | 30 | | | | | | | | | 1 | |
| | Transition | 0.25 | | | | | | | | | | |
| Nano-Particles | Set-up G1 | 2 | | 1 | | | | | | | | |
| | G1 | 2 | 1 | 1 | | | | | | | | |
| | injection | | | | | | | | | | | |
| | G1 Purge | 5 | | 1 | | | | | | | | |
| | G1 2nd | 1 | 1 | 1 | | | | | | | | |
| | Pulse | | | | | | | | | | | |
| | G1 Purge | 3 | | 1 | | | | | | | | |
| | Dispersion | 2 | | | | | | | | | | |
| | of G1 | | | | | | | | | | | |
| | G3 Setup | 2 | | | | | | 1 | | | | |
| | G3 | 2 | | | | | 1 | 1 | | | | |
| | Injection | | | | | | | | | | | |
| | G3 Purge | 5 | | | | | | 1 | | | | |
| | Reaction | 30 | | | | | | | | | | |
| | G1 + G3 | | | | | | | | | | | |
| | Blow Out | 5 | | 1 | | 1 | | 1 | | 1 | 1 | |
| | Pump out | 30 | | | | | | | | | 1 | |
| Surface Treatment | Transition | 0.25 | | | | | | | | | | |
| | G3 Setup | 2 | | | | | | 1 | | | | |
| | G3 | 2 | | | | | 1 | 1 | | | | |
| | Injection | | | | | | | | | | | |
| | G4 Purge | 10 | | | | | | 1 | | | | |
| | Diffusion | 5 | | | | | | | | | | |
| | step | | | | | | | | | | | |
| | G2 Set-up | 2 | | | | 1 | | | | | | |
| | G2 | 10 | | | 1 | 1 | | | | | | |
| | Injection | | | | | | | | | | | |
| | G2 Purge | 10 | | | | 1 | | | | | | |
| | Reaction | 600 | | | | | | | | | | |
| | G2 + G3 | | | | | | | | | | | |
| | Pump | 30 | | | | | | | | | 1 | |
| | Down | | | | | | | | | | | |
| | Back Fill | 10 | | | | | | | | | | 1 |
| | Flush | | | | | | | | | | | |
| | Final | 45 | | | | | | | | | 1 | |
| | Pump | | | | | | | | | | | |
| | Down | | | | | | | | | | | |
| | Chamber | 200 | | | | | | | | | | 1 |
| | Vent | | | | | | | | | | | |

Table 4 provides a process flow for use with the apparatus illustrated in FIG. 7. G1, G2, G3 and G4 represent input to the different gas lines from precursor sources, and N₂1, N₂2, N₂3 and N₂4 represent the corresponding carrier gas lines. During the deposition of the VCI layer, G1 is tri-methyl aluminum (TMA), G2 is perfluoro-octyl-trichlorosilane (FOTS), G3 is water and G4 is BTA. During the deposition of the anti-wetting barrier, i.e., the nano-particles and surface treatment, G1 is TMA, G2 is FOTS, G3 is water and G4 is bis-trichlorosilane-ethane. G4 is switched from BTA to bis-trichlorosilane-ethane after deposition of the VCI layer. A system with 5 input gas lines could be readily implemented and would not need such a switch-over. ISO is the “isolation” or main vacuum pump, controlled by valve 782 in FIG. 7. Time is provided in seconds.

Sample 12D was first coated with a VCI using the process described for Sample 12B, then with an anti-wetting barrier using the process described for Sample 12C.

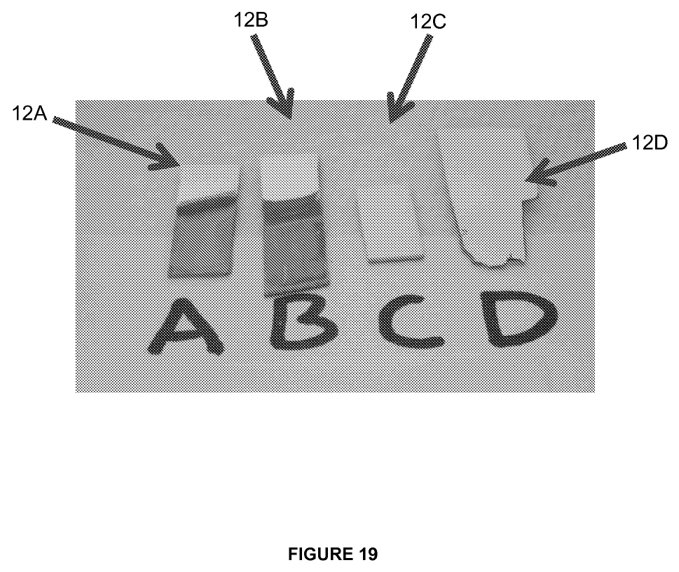

Sample 12A, 12B, 12C and 12D were each dipped for one minute in a 0.1 M copper chloride solution, and visually inspected. Samples 12A and 12B both showed corrosion where dipped, indicating that the VCI alone does not provide protection against this type of corrosion. Samples 12C and 12D did not show corrosion where dipped, indicating that the anti-wetting barrier does provide protection against this type of corrosion, both alone (Sample 12C) and when used in conjunction with a VCI (Sample 12D). FIG. 19 shows samples 12A, 12B, 12C and 12D after testing.

### EXAMPLE 13

Various samples were prepared using 500 Å Cu coated on silicon as a substrate. The samples had further treatment as follows:
Treatment 1A: Wet VCI
Treatment 1B: no treatment
Treatment 1C: Vapor VCI
Treatment 1D: Wet VCI, vapor deposited anti-wetting barrier
Treatment 1E: no VCI, vapor deposited anti-wetting barrier
Treatment 1F Long wet VCI, vapor deposited anti-wetting barrier
Treatment 1G Wet VCI, vapor deposited anti-wetting barrier
Treatment 1H no treatment
Treatment 1J Vapor VCI, vapor deposited anti-wetting barrier

“Wet VCI” was applied as described in Example 12, using a solution of 1% BTA in isopropyl alcohol (IPA).

“Long wet VCI” is similar to “Wet VCI,” but for Long Wet VCI the solution is 0.5% BTA in isopropyl alcohol (IPA), and the immersion time is 5 minutes.

“Vapor deposited VCI” was applied as described in Table 4, using the steps labeled “VCI.”

“Vapor deposited anti-wetting barrier” was deposited as described in Table 4, using the steps labeled “nano-particles” and “surface treatment.”

Samples labeled 1A, 1B, 1C, 1D, 1E, 1F, 1G, 1H and 1J were initially shiny in appearance. The samples were subjected to a humidity stress test. The samples were exposed to 85% relative humidity (RH), where water was responsible for the humidity, at 85° C., for 24 hours. During the humidity stress test, the samples were held with their surfaces in a vertical orientation. Droplets formed on the samples and dripped off.

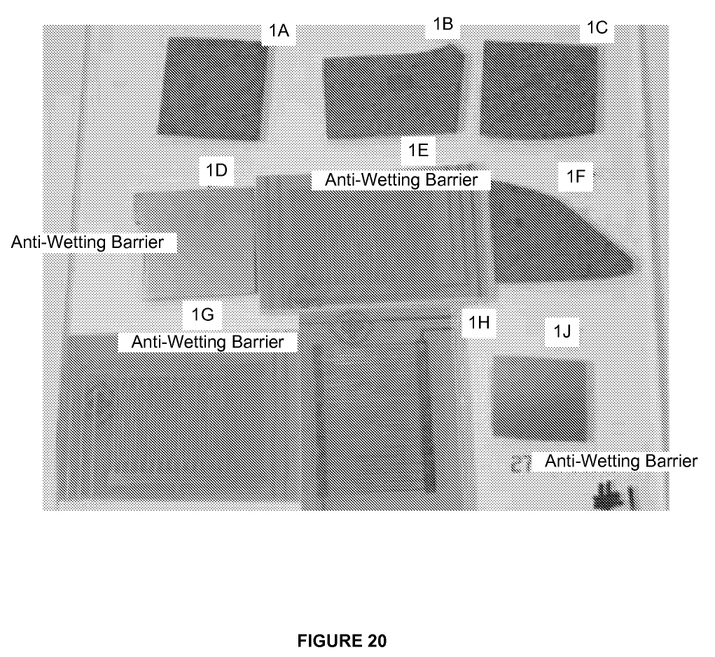

1A, 1B, 1C, 1D, 1E, 1F, 1G, 1H and 1J were visually inspected after the humidity stress test. Samples 1A, 1B, 1C, 1F and 1H exhibited significant corrosion. Samples 1D, 1E, 1G and 1J exhibited much less corrosion, and retained a shiny appearance. FIG. 20 shows samples 1A, 1B, 1C, 1D, 1E, 1F, 1G, 1H and 1J after the humidity stress test.

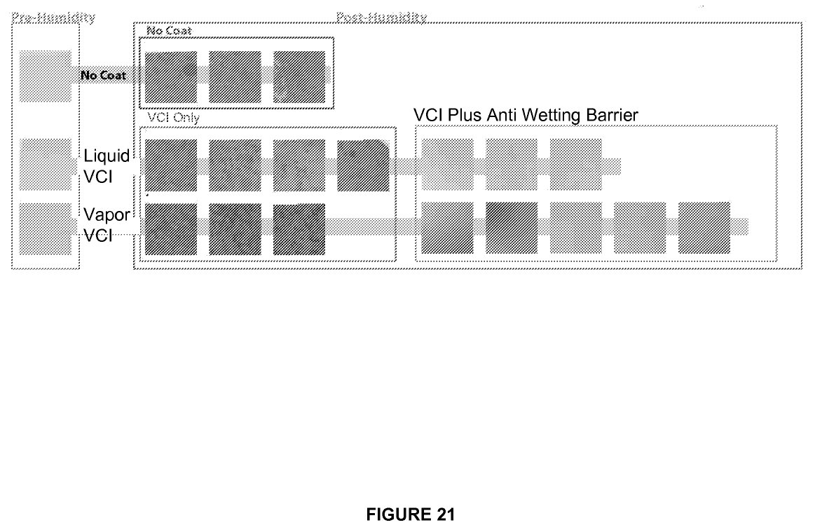

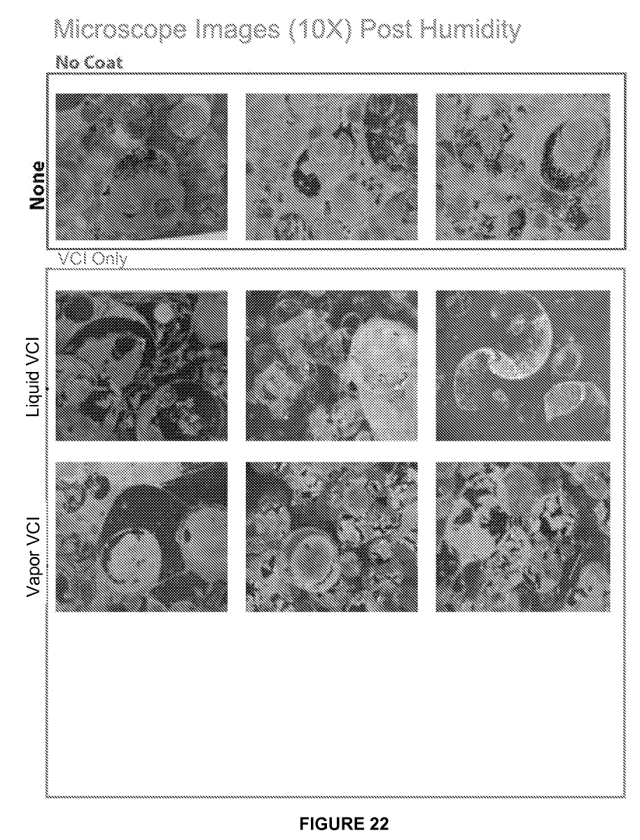

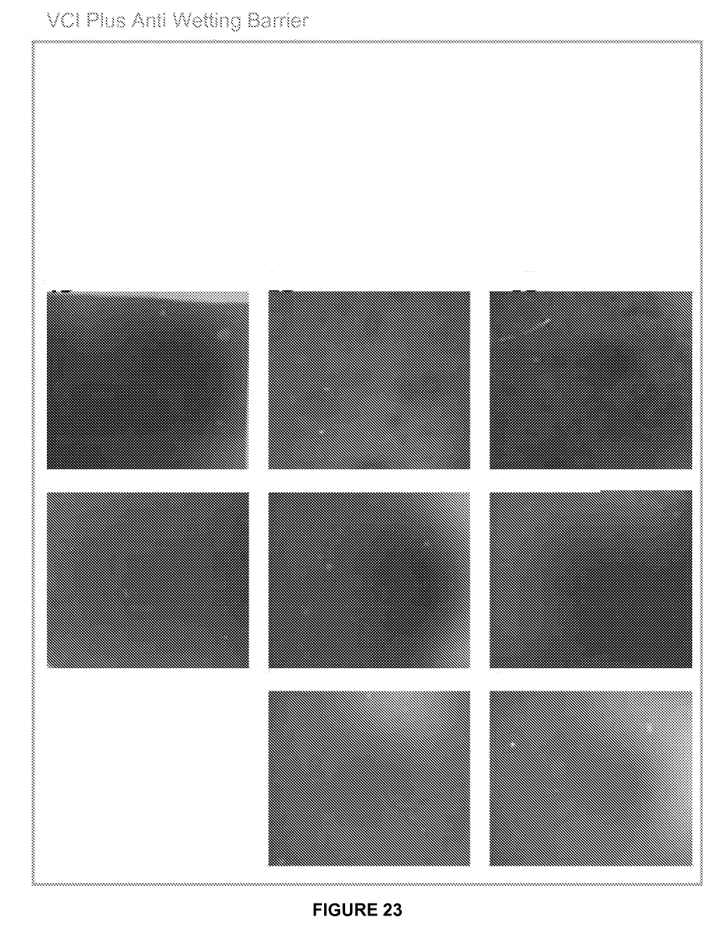

FIG. 21 shows additional samples having either no coating, just a VCI layer, or a VCI layer plus an anti-wetting barrier, after being subjected to a humidity stress test. FIG. 22 shows magnified views of samples without an anti-wetting barrier, and FIG. 23 shows magnified views of samples with an anti-wetting barrier. As with FIG. 20, samples having an anti-wetting barrier exhibited much less corrosion.

What is claimed is:

1. A corrosion barrier disposed on a substrate, wherein the corrosion barrier comprises:
an anti-wetting barrier disposed over the substrate, the anti-wetting barrier comprising a nano-particle composite structure; and
a vapor corrosion inhibitor material.

2. The corrosion barrier of claim 1, wherein the corrosion barrier further comprises:
a vapor corrosion inhibitor layer disposed on the substrate, comprising the vapor corrosion inhibitor material;
wherein the anti-wetting barrier is disposed over the vapor corrosion inhibitor layer.

3. The corrosion barrier of claim 2, wherein the anti-wetting barrier is disposed on the vapor corrosion inhibitor layer.

4. The corrosion barrier of claim 1, wherein the anti-wetting barrier further comprises the vapor corrosion inhibitor material.

5. The corrosion barrier of claim 1, wherein the vapor corrosion inhibitor material is selected from the group consisting of sodium hexametaphosphate, diethylaminoethanol, dicyclohexyl amine nitrite, camphor, benzotriazole, dicyclohexyl amine nitrite, cyclohexlamine carbonate, morpholine, cyclohexylamine aniline, benzylamine, N-cyclohexyl-n-dodecylamine, piperidine and di-n-butylamine.

6. The corrosion barrier of claim 2, wherein the vapor corrosion inhibitor layer comprises benzotriazole.

7. The corrosion barrier of claim 6, wherein the vapor corrosion inhibitor layer comprises a one-molecule thick layer of benzotriazole.

8. The corrosion barrier of claim 6, wherein the substrate is copper.

9. The corrosion barrier of claim 6, wherein the substrate comprises a material selected from the group consisting of copper, iron, silver, aluminum, tin, zinc, and alloys thereof.

10. The corrosion barrier of claim 1, wherein the corrosion barrier comprises an organic material.

11. The corrosion barrier of claim 1, wherein the nano-particle composite structure has:
an RMS surface roughness of 25 nm to 500 nm;
a film coverage of 25% to 60%
a thermodynamic surface energy of <70 dyne/cm; and

12. The corrosion barrier of claim 11, wherein the corrosion barrier has a durability of 10 to 5000 microNewtons.

13. The corrosion barrier of claim 12, wherein the substrate is a printed circuit board.

14. The corrosion barrier of claim 11, wherein the corrosion barrier has a durability of 10 to 500 microNewtons.

15. The corrosion barrier of claim 1, wherein the anti-wetting barrier comprises non-conductive particles linked to each other and to the substrate by linker molecules.

16. The corrosion barrier of claim 15, wherein the non-conductive particles are metal oxide or semiconductor oxide particles.

17. The corrosion barrier of claim 15, wherein the non-conductive particles are alumina or silica particles.

18. The corrosion barrier of claim 15, wherein the non-conductive particles are alumina particles have a particle size of about 40-60 nm.

19. The corrosion barrier of claim 15, wherein the non-conductive particles are silica particles have a particle size of about 10-20 nm.

20. The corrosion barrier of claim 15, wherein the non-conductive particles are latex particles.

21. The corrosion barrier of claim 15, wherein the linker molecules are selected from the group consisting of bi-functional linkers such as bis-trichlorosilane-ethane, bis-trichlorosilane-butane, bis-trichlorosilane-hexane, bis-trimethoxysilane-ethane, bis-trimethoxysilane-butane, bis-trimethoxysilane-hexane, bis-tris-dimethylaminosilane-ethane, bis-tris-dimethylaminosilane-butane, bis-tris-dimethylaminosilane-hexane and tetrachlorosilane.

22. The composite of claim 15, wherein the linker molecules are silanes with a reactive group at both ends.

23. The corrosion barrier of claim 15, wherein the anti-wetting barrier further comprises a low thermodynamic surface energy coating, having a surface energy of less than 70 dyne/cm, disposed over the non-conductive particles and linker molecules.

24. The corrosion barrier of claim 15, wherein the low surface energy coating comprises a material selected from the group consisting of long chain hydrocarbons, long chain fluorocarbons, phosphonates, thiols and ring structures.

25. The corrosion barrier of claim 15, wherein the low surface energy coating comprises a material selected from the group consisting of C8, C10, C11, C12, C14, C18, FDTS, FODCMS or FOTS.

26. The corrosion barrier of claim 1, wherein the nano-particle composite structure has a water vapor transmission rate of 0.01 to 3 g/(m²*day).

27. The corrosion barrier of claim 1, wherein the substrate is a consumer electronic device.

28. The corrosion barrier of claim 1, wherein the corrosion barrier has a total thickness of 0.05 to 15 microns.

29. The corrosion barrier of claim 2, wherein:
the vapor corrosion inhibitor layer comprises a material selected from the group consisting of sodium hexametaphosphate, diethylaminoethanol, dicyclohexyl amine nitrite, camphor, benzotriazole, dicyclohexyl amine nitrite, cyclohexlamine carbonate, morpholine, cyclohexylamine aniline, benzylamine, N-cyclohexyl-n-dodecylamine, piperidine and di-n-butylamine; and
the anti-wetting barrier further comprises:
non-conductive particles linked to each other and to the substrate by linker molecules; and
a low thermodynamic surface energy coating disposed over the non-conductive particles and linker molecules, the low surface energy coating comprising a material selected from the group consisting of long chain hydrocarbons, long chain fluorocarbons, phosphonates, thiols and ring structures.

30. A method of fabricating a corrosion barrier, comprising:
providing a vapor corrosion inhibitor layer on a substrate; and
depositing, via a vapor process, an anti-wetting barrier over the vapor corrosion inhibitor layer, the anti-wetting barrier comprising a nano-particle composite structure.

31. The method of claim 28, wherein the vapor corrosion inhibitor layer is provided by depositing the vapor corrosion inhibitor layer via a vapor process.

32. The method of claim 28, wherein the vapor corrosion inhibitor layer is provided by depositing the vapor corrosion inhibitor layer via a wet process.
